(19) United States
(12) Patent Application Publication
(10) Pub. No.: US 2013/0046638 A1
(43) Pub. Date: Feb. 21, 2013

(54) KNOWLEDGE-BASED SYSTEM AND METHOD FOR CAPTURING CAMPAIGN INTENT TO EASE CREATION OF COMPLEX VDP MARKETING CAMPAIGNS

(71) Applicants: Michael David Shepherd, Ontario, NY (US); Dale Ellen Gaucas, Penfield, NY (US); Kirk J. Ocke, Ontario, NY (US); Reuven J. Sherwin, Ra'anana (IL); Barry G. Gombert, Rochester, NY (US)

(72) Inventors: Michael David Shepherd, Ontario, NY (US); Dale Ellen Gaucas, Penfield, NY (US); Kirk J. Ocke, Ontario, NY (US); Reuven J. Sherwin, Ra'anana (IL); Barry G. Gombert, Rochester, NY (US)

(73) Assignee: XEROX CORPORATION, Norwalk, CT (US)

(21) Appl. No.: 13/211,437

(22) Filed: Aug. 17, 2011

(51) Int. Cl. G06Q 30/00

(52) U.S. Cl. 705/14.67

(57) ABSTRACT

As set forth herein, computer-implemented methods and systems facilitate providing an approach for using defined patterns of variable-data campaigns to enable a marketing service provider to express a non-expert user's desired campaign intent, using natural language and campaign intent terms, as well as to accurately capture the non-expert user's intent by communicating using non-technical campaign terminology. Communication of semantically robust campaign intent to variable-data campaign graphic designers and developers is facilitated by the described systems and methods, as is automated creation of a variable-data logic (plan) file based on semantic campaign intent. The described systems and methods facilitate the creation of variable data publishing (VDP) marketing campaigns by the non-expert, as well as communication and collaboration with the rest of a VDP design team.

### TECHNICAL FIELD

The presently disclosed embodiments are directed toward methods and systems for generating a marketing campaign. More particularly, the teachings disclosed herein are applicable to methods and apparatuses for capturing a user's intent when generating a marketing campaign. It will be appreciated that the described systems and methods may find application in other fields.

### BACKGROUND

Data suggests that somewhere between 30-40% of marketing campaigns are personalized, most of which only vary content based on the recipient's name. First-name and last-name are simple textual data values that can be leveraged in a limited capacity on a personalized document (e.g., embedded in textual message or in an image). As CRM (customer relations management) systems become more sophisticated, much more data becomes available in which campaigns can be personalized for customers or prospects. The data (e.g. first-name, last-name, age, gender) and logic (a.k.a “business rules”—e.g. “if gender is male and age is less than 30, then special offer=iPhone otherwise special offer=Blackberry) aspects of a variable data publishing (VDP) plan creation are difficult and time consuming. Marketing Service Providers (MSPs) invest large amounts of time understanding the desires of the campaign customer, testing the specific campaign requirements, and creating the logic necessary to fulfill the campaign intent.

There is a need in the art for systems and methods that facilitate identifying the intent of a user designing a marketing campaign while overcoming the aforementioned deficiencies.

### BRIEF DESCRIPTION

In one aspect, a computer-implemented method for personalizing a variable data publishing (VDP) marketing campaign pattern comprises receiving user input related to an intended campaign purpose from a non-expert user, automatically selecting a VDP pattern from a plurality of a pre-generated VDP pattern as a function of the intended campaign purpose, retrieving product information to be presented on campaign documents for distribution to a plurality of recipients, and receiving recipient information to appear on the campaign documents. The method further comprises prompting the user, as a function of the intended campaign purpose, to specify personalization parameters for personalizing the campaign documents, receiving user-specified personalization parameter information, and outputting a personalized VDP pattern instance for use in generating the campaign documents.

In another aspect, a system that facilitates personalizing a variable data publishing (VDP) marketing campaign pattern comprises a graphical user interface (GUI) via which a user interacts with a campaign creation application that is persistently stored on a computer-readable medium, and a processor that executes the campaign creation application and is configured to receive user input related to an intended campaign purpose from a non-expert user and automatically select a VDP pattern from a plurality of a pre-generated VDP patterns as a function of the intended campaign purpose. The processor is further configured to retrieve product information to be presented on campaign documents for distribution to a plurality of recipients, the product information being retrieved from a product data source provided by the user, and to receive recipient information to appear on the campaign documents, the recipient information being provided in a recipient data source provided by the user. Additionally, the processor is configured to prompt the user, as a function of the intended campaign purpose, to specify personalization parameters for personalizing the campaign documents, to receive user-specified personalization parameter information, and to output a personalized VDP pattern instance for use in generating the campaign documents.

In yet another aspect, a computer-readable medium having persistently stored thereon computer-executable instructions for personalizing a variable data publishing (VDP) marketing campaign pattern comprises instructions for receiving user input related to an intended campaign purpose from a non-expert user, and automatically selecting a VDP pattern from a plurality of a pre-generated VDP patterns as a function of the intended campaign purpose. The computer-readable medium further comprises instructions for retrieving product information to be presented on campaign documents for distribution to a plurality of recipients, receiving recipient information to appear on the campaign documents, prompting the user, as a function of the intended campaign purpose, to specify personalization parameters for personalizing the campaign documents, receiving user-specified personalization parameter information, and outputting a personalized VDP pattern instance for use in generating the campaign documents.

### BRIEF DESCRIPTION OF THE DRAWINGS

The file of this patent contains at least one drawing executed in color. Copies of this patent with color drawing(s) will be provided by the U.S. Patent and Trademark Office upon request and payment of the necessary fee.

FIG. 1 illustrates a method for identifying campaign designer intent in which a VDP non-expert user can express the desired VDP logic for a personalized marketing campaign.

FIG. 2 shows an example VDP Pattern called “Product Offer.”

FIG. 3 illustrates a plurality of examples of VDP patterns, such as may be employed in conjunction with various aspects described herein.

FIG. 4 illustrates a system that facilitates identifying user intent when generating a marketing campaign in order to infer an appropriate VDP pattern and populate the pattern with personalized information, in accordance with one or more aspects described herein.

FIG. 5 shows a screenshot of an example advertisement or offer that is presented to a customer by a merchant or proprietor.

FIG. 6 shows a screenshot of an example advertisement or offer that is presented to a second recipient by the merchant or proprietor.

FIG. 7 illustrates a screenshot of a screen presented to a user (i.e., a campaign designer) during campaign creation when the wizard application is being executed, in accordance with one or more aspects described herein.

FIG. 8 shows a screenshot of a screen presented to a user during campaign creation when the wizard application is being executed, in accordance with one or more aspects described herein.

FIG. 9 shows a screenshot from the campaign creation wizard in which the user identifies a list of store locations that can be used to determine which is closest to the recipient's residence or other address on file.

FIG. 10 shows a screenshot from the campaign creation wizard in which the user identifies customer information that the user desires to have displayed in the campaign documents.

FIG. 11 shows a screenshot from the campaign creation wizard in which the user is presented with a number of buttons that can be selected to enter additional information.

FIG. 12 shows a screenshot from the campaign creation wizard in which the user is presented with a number of selectable product parameters related to example VDP pattern element “Product” information to be displayed on the campaign document.

FIG. 13 shows a screenshot from the campaign creation wizard in which the user is presented with a number of selectable customer parameters that are employed by the wizard application to vary example VDP pattern element “Products” offered to customers listed in the recipient data source.

FIG. 14 shows a screenshot from the campaign creation wizard in which the user has selected “pet preference” as a parameter by which to vary Product offerings among different customers.

FIG. 15 shows a screenshot from the campaign creation wizard in which the user is presented with a number of selectable parameters that are employed by the wizard application to vary the example VDP pattern element “Rewards” offered to customers listed in the recipient data source.

FIG. 16 shows a screenshot from the campaign creation wizard in which the user has selected “spend level” as a parameter by which to vary Reward offerings among different customers.

FIG. 17 shows a screenshot from the campaign creation wizard in which the user is presented with a number of selectable options for displaying text and/or a website address to customers listed in the recipient data source.

FIG. 18 shows a screenshot from the campaign creation wizard in which the user has selected to display common text to all customers, and has entered the text in a designated field.

FIG. 19 shows a screenshot from the campaign creation wizard in which the user has selected to display varying animal images to different customers, based on the customer's pet preference.

FIG. 20 shows a screenshot from the campaign creation wizard in which the user is prompted to specify the images that are to be tagged with the metatag “Animal.”

FIG. 21 shows a screenshot from the campaign creation wizard in which the user is presented with a number of selectable images for presenting to customers listed in the recipient data source.

FIG. 22 shows a screenshot from the campaign creation wizard in which the user is presented with a number of selectable default animal type images to be presented to customers listed in the recipient data source.

FIG. 23 shows a screenshot from the campaign creation wizard in which the user is prompted to specify formats in which to save the marketing campaign.

FIG. 24 shows a screenshot of an example advertisement or offer that is presented to a customer by a merchant or proprietor.

FIG. 25 shows a screenshot showing the back of the example advertisement of offer.

FIG. 26 illustrates a screenshot of a screen presented to a user (i.e., a campaign designer) during campaign creation when the wizard application is being executed.

FIG. 27 shows a screenshot of a screen presented to a user during campaign creation when the wizard application is being executed, in accordance with one or more aspects described herein.

FIG. 28 shows a screenshot from the campaign creation wizard in which the user identifies personal customer information that the user desires to have displayed in the campaign documents.

FIG. 29 shows a screenshot from the campaign creation wizard in which the user is presented with a number of selectable parameters that are employed by the wizard application to vary the example VDP pattern element “Gifts” (i.e., discount amounts or the like) offered to customers listed in the recipient data source.

FIG. 30 shows a screenshot from the campaign creation wizard in which the user has selected “club level” as a parameter by which to vary gift offerings among different customers.

FIG. 31 shows a screenshot from the campaign creation wizard in which the user is presented with a number of selectable options for displaying text and/or a website address to customers listed in the recipient data source.

FIG. 32 shows a screenshot from the campaign creation wizard in which the user has selected to display varying text to all customers based on the customers' activation of different services (e.g., email, internet, etc.), and has entered the text in corresponding designated fields.

FIG. 33 shows a screenshot from the campaign creation wizard in which the user has selected to display the same text to all customers.

FIG. 34 shows a screenshot from the campaign creation wizard in which the user has selected to display a response URL to all customers.

FIG. 35 shows a screenshot from the campaign creation wizard in which the user has selected to customize the response URL as a function of recipients' respective last names.

FIG. 36 shows a screenshot from the campaign creation wizard in which the user has selected to display varying phone images based on the recipients' respective phone models.

FIG. 37 shows a screenshot from the campaign creation wizard in which the user is prompted to specify pre-stored images that are to be tagged as being phone images.

FIG. 38 shows a screenshot from the campaign creation wizard in which the user has selected pre-stored images that are to be tagged as being phone images from a database of pre-stored images related to the marketing campaign.

FIG. 39 shows a screenshot from the campaign creation wizard that shows the user that the user-provided customer data source has been analyzed and source values related to each recipient's phone model have been automatically associated with the user-selected phone images via analysis of the selected phone images.

FIG. 40 shows a screenshot from the campaign creation wizard in which the user has selected to display varying logo images based on the recipients' club level.

FIG. 41 shows a screenshot from the campaign creation wizard in which the user is prompted to specify pre-stored images that are to be tagged as being logo images.

FIG. 42 shows a screenshot from the campaign creation wizard in which the user has selected pre-stored images that are to be tagged as being logo images from a database of pre-stored images related to the marketing campaign.

FIG. 43 shows a screenshot from the campaign creation wizard in which the user is prompted to specify a visibility rule from a menu.

### DETAILED DESCRIPTION

The above-described problem is solved by providing a knowledge-assisted method in which a VDP (variable data printing/publishing) non-expert can express his or her desired VDP logic for a VDP campaign. The technique is supported by a knowledge-base (e.g., a database+entity logic) of common types of VDP campaigns. Through the semantic expression of VDP elements and logic, the MSP can more easily and accurately convey the desired campaign intent to the team members collaborating on the campaign. Additionally, the MSP can more accurately align the execution of the campaign as expected by the client, as the patterns provide a more natural nomenclature for expressing campaign intent. Expression of campaign intent can automatically be reified into an executable campaign plan and corresponding data schema.

Highly personalized marketing can be significantly more successful by making the most effective use of customer data for creating an exceptional personalized experience, whether acquiring new customers or retaining and up-selling existing customers. The potential complexity of personalization grows with the amount of data resources accessible by the MSP. Thereby the logic involved in driving a personalized campaign can become very complicated. Larger available data sources cause complexity to grow in two directions: first, the implicit knowledge that can be derived from the explicit data in the data source; and second, the number and quality of decisions needed to be made based on the implicit and explicit data in order to create the highly personalized document.

As CRM systems become more sophisticated, they will not only incorporate more customer static and historical data, but will also be able to learn much more about a customer or prospect via web queries, real-time data, and interaction with online social media, as well as targeting via psychographics. As more customer data, both explicit and implicit, becomes available, there will emerge a need to express the logic of a marketing campaign using more robust automated knowledge techniques. As a result, many campaigns may be prone to either ignoring marketing opportunities hidden in the data due to the complexity of mining the data (resulting in less-effective campaigns) or requiring highly skilled database programming experts (resulting in high campaign costs). The subject innovation provides systems and methods that facilitate meeting the above-described needs in order to take advantage of more complex data and to improve marketing campaign personalization.

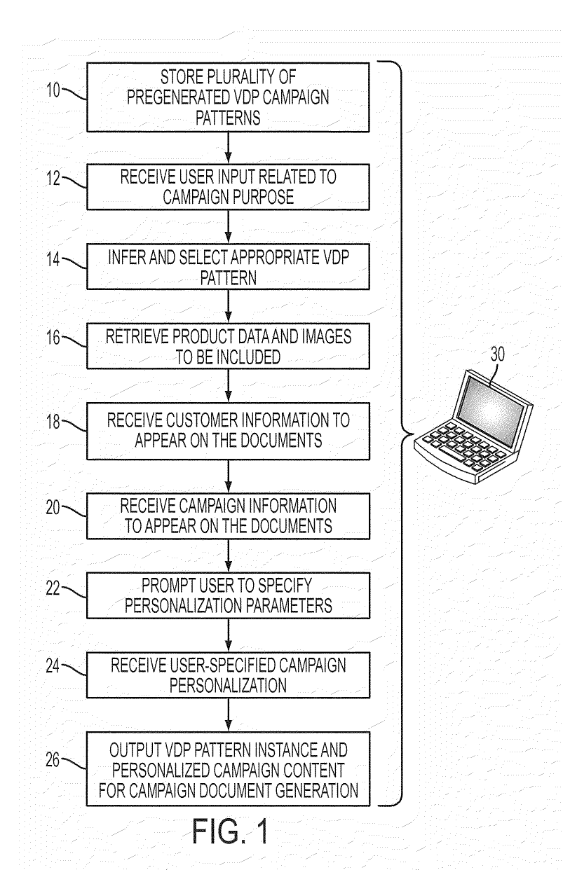

FIG. 1 illustrates a method for identifying campaign designer intent in which a VDP non-expert user, also referred to herein as a “campaign designer,” can express the desired VDP logic for a personalized marketing campaign. Accordingly, at 10, a plurality of pre-generated campaign patterns are stored (e.g., in a memory, computer-readable medium, etc.). These campaign patterns are hereafter referred to as “VDP Patterns.” Types of VDP Patterns include, without being limited to, Product Offer, Advertisement, Solicitation, Invitation, Announcement, Recall, Reminder, Survey, Greeting Card, Itinerary, etc. Additionally, each VDP Pattern is semantically defined and represented to contain VDP elements specific to that VDP Pattern. “VDP elements” denote high-level concepts that are typically populated by variable content. At 12, user input is received, which describes a campaign purpose (e.g., a sale, incentive, service, etc.). At 14, an appropriate VDP pattern is inferred based on the user's indicated campaign purpose and selected for populating with user-provided recipient-specific information. At 16, existing data and images to be used in the VDP pattern are received. The existing data and images can be entered (e.g., downloaded) by the campaign designer and/or can be selected from a database of stored images and/or data.

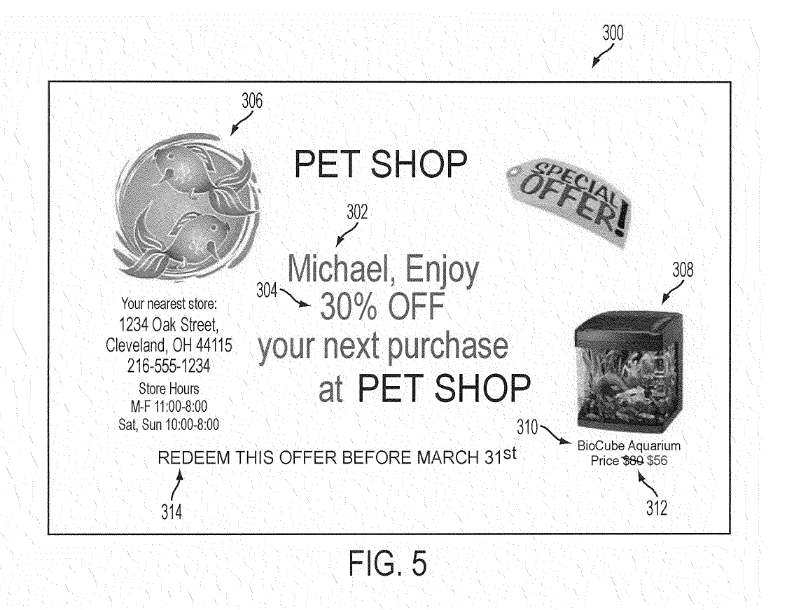

At 18, customer information to appear on the campaign documents is received. For instance, the designer can download or import customer data from a source, such as a spreadsheet or the like. At 20, campaign information to appear in the document(s) is received. Campaign information may include, for instance, a coupon or reward, a sale data and location, or any other information the designer wishes to disseminate to one or more customers. At 22, the user is prompted to specify personalization parameters for the campaign. User prompts are a function of the selected VDP pattern, which in turn has been selected as a function of the user's specified campaign intent. At 24, user-specified campaign personalization is performed. For instance, a user may wish to personalize the VDP pattern to include variable data such as name, nearest store to the named customer, and coupon size (e.g., which may be a function of an amount the named customer spent at the store in a previous time period or the like). At 26, the personalized VDP pattern and campaign content are output (e.g., on a graphical user interface, via a print-out, via email, or some other suitable means) for review and verification and for generating the campaign documents (e.g., personalized emails, post cards, mailers, web-based advertisements, etc.). Examples of the personalization of the campaign as developed through user interaction with the herein-described campaign creation wizard application and through execution of the method of FIG. 1 are shown in detail with regard to FIGS. 5-43.

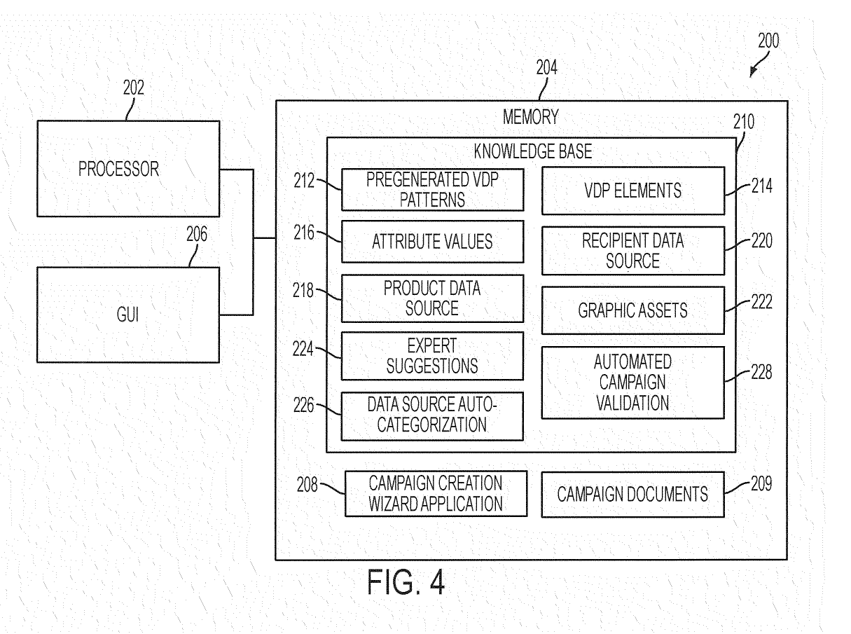

It will be appreciated that the method of FIG. 1 can be implemented by a computer 30, which comprises a processor (such as the processor 202 of FIG. 4) that executes, and a memory (such as the memory 204 of FIG. 4) that stores, computer-executable instructions for providing the various functions, etc., described herein.

The computer 30 can be employed as one possible hardware configuration to support the systems and methods described herein. It is to be appreciated that although a standalone architecture is illustrated, that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiment.

The computer 30 can include a processing unit (see, e.g., FIG. 4), a system memory (see, e.g., FIG. 4), and a system bus (not shown) that couples various system components including the system memory to the processing unit. The processing unit can be any of various commercially available processors. Dual microprocessors and other multi-processor architectures also can be used as the processing unit.

The computer 30 typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of he above can also be included within the scope of computer readable media.

A user may enter commands and information into the computer through an input device (not shown) such as a keyboard, a pointing device, such as a mouse, stylus, voice input, or graphical tablet. The computer 30 can operate in a networked environment using logical and/or physical connections to one or more remote computers, such as a remote computer(s). The logical connections depicted include a local area network (LAN) and a wide area network (WAN). Such networking environments are commonplace in offices, enterprise-wide computer networks, intranets and the Internet.

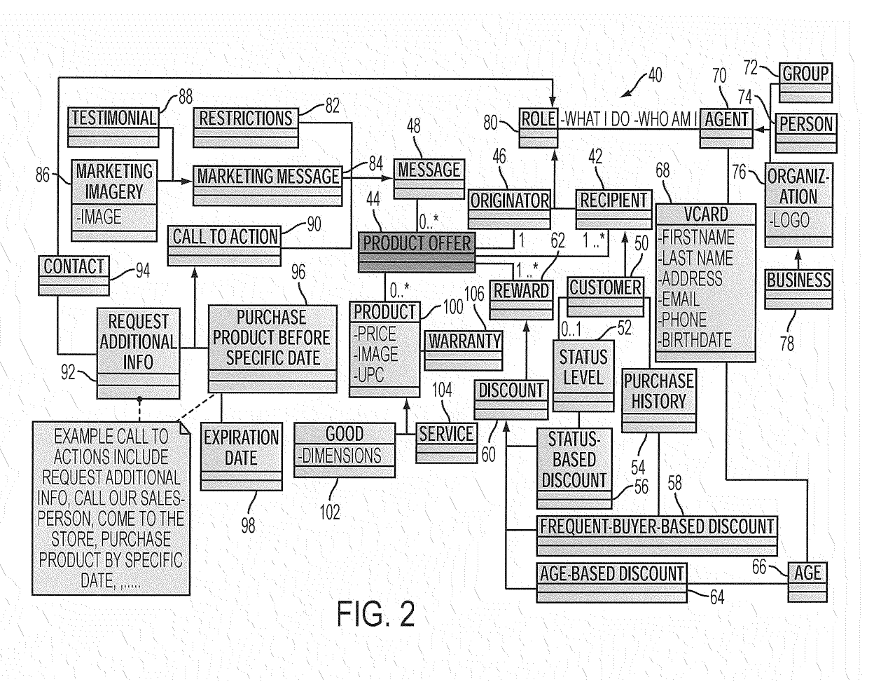

FIG. 2 shows an example VDP Pattern 40 called “Product Offer.” The surrounding boxes are the supporting VDP elements. “Element” as used herein denotes both a computer-readable medium or portion thereof that stores information, as well as a populatable and personalizable field into which the information may be entered by a user. For instance, a user may enter information into a given field presented to the user on a graphical user interface, and/or the information may be downloaded or extracted from an electronic document or source and automatically entered into appropriate fields. Once entered, the information is then stored at a predefined location in a system memory. Although the herein-described knowledge-base has in-depth knowledge of the relationships between elements, the system and method defined herein uses the VDP concepts most directly related to the specific VDP Pattern for illustrative purposes. Some VDP elements are shared across many VDP Patterns. For instance, every VDP Pattern, by the definition of VDP campaign, has a recipient element 42. As another example, Offers, Recalls, and Warranty Extensions typically all share the Product element 44. Different campaigns can use different VDP elements of the VDP Patterns. In one embodiment, some elements may be mandatory while others may be optional.

The VDP pattern 40 also includes an originator element 46 that originates the offer or marketing campaign, as well as a message element 48 that includes a message for the recipient. The recipient may be a customer of the campaign designer (e.g., a merchant), and therefore the pattern 40 includes a customer element 50. Each customer has a status level 52 and a purchase history 54, which can be analyzed to generate a status-based discount 56 and/or a frequent-buy-based discount 58. Information from the status-based discount element 56 and/or the frequent-buyer-based discount element 58 is provided to a discount element 60, which in turn provides information to a reward element 62 that generates a reward for inclusion in the product offer 44. An age-based discount element 64 can provide age-based discount information to the discount element 60. A customer's age 66 is stored or determined by an age element 66, such as by analyzing or storing a vcard 68 or the like.

The VDP pattern 40 also includes elements associated with an agent who can help the campaign designer design the marketing campaign. For instance, an agent element 70 comprises information regarding the identity of the agent, which may be collected from a group element 72 that identifies multiple agents, from a person element 74 that identifies a single agent, and/or from an organization element 76 that identifies an organization that acts as an agent. A business element 78 includes information related to the business of the organization acting as an agent. The agent element has is populated with a desired level of information describing the identity of the agent, and is associated with a role element 80 that includes information related to one of more functions or services provided by the agent.

The message element 48 can include one or more message types such as one or more restrictions on the product offer, which are stored in a restrictions element 82. The message may also include a marketing message that is stored in a marketing message element 84. The marketing message may include marketing imagery obtained from a marketing imagery element 86 that stores images, as well as testimonial information (i.e., testimonials for satisfied customers or the like) that are stored in a testimonial element 88. Additionally, the message 48 can include one or more calls to action that are stored in a call to action element 90. In one example, the call to action includes a request for additional information 92, in which case a contact element 94 is executed to contact either the recipient of the product offer or an agent (e.g., via the role element 80) who then contacts the recipient. In another example, the call to action includes an offer deadline, e.g., stored in a “purchase product before specific date” element 96. The deadline information for a given product offer is stored in an expiration date element 98.

The product offer 44 may also include product information, which is stored in a product element 100, and which may include, without limitation, one or more of product price, an image of the product, UPC information for the product, etc. A good element 102 includes product information for one or more goods, such as dimension and the like, while a service element 104 includes information related to a service that is to be offered. A warranty element 106 includes information related to product warranty, which can be included in the product offer 44.

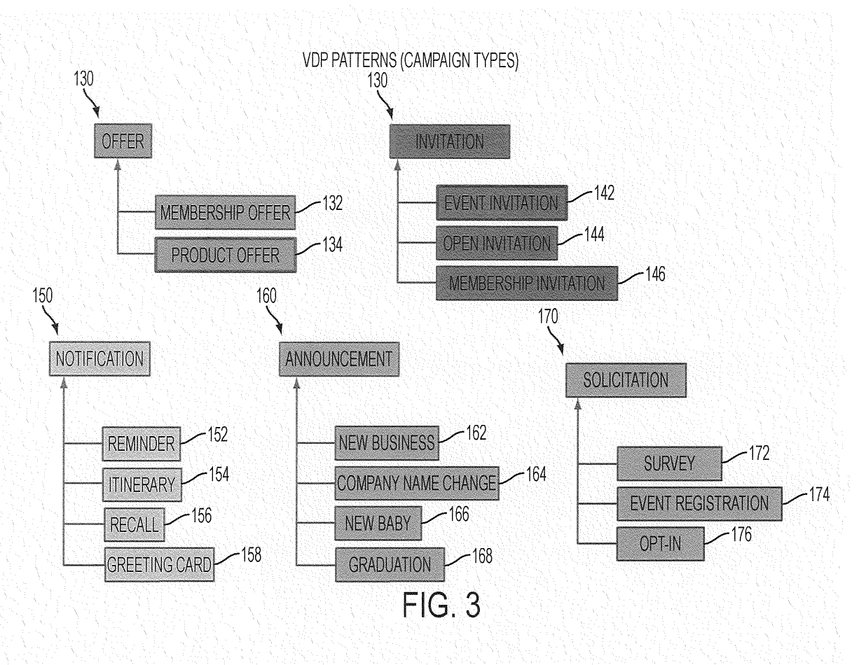

FIG. 3 illustrates a plurality of examples of VDP patterns, such as may be employed in conjunction with various aspects described herein. An offer VDP pattern 130 can include, for example, a membership offer 132 and/or a product offer 134. An invitation VDP pattern 140 can include, for example, an event invitation 142, an open invitation 144, and/or a membership invitation 146. A notification VDP pattern 150 may include, for example, a reminder 152, an itinerary 154, a product recall 156, and/or a greeting card 158. An announcement VDP pattern 160 can include, for example, a new business announcement 162, a company name change announcement 164, a new baby announcement 166, and/or a graduation announcement 168. A solicitation VDP pattern 170 can include, for example, a survey 172, an event registration form 174, and/or an opt-in form 176.

FIG. 4 illustrates a system 200 that facilitates identifying user intent when generating a marketing campaign in order to infer an appropriate VDP pattern and populate the pattern with personalized information, in accordance with one or more aspects described herein. The system comprises a processor 202 that executes, and a memory 204 that stores computer-executable instructions for performing the various functions, methods, techniques, steps, and the like described herein. The processor 202 and memory 204 may be integral to each other or remote but operably coupled to each other. In another embodiment, the processor and memory reside in a computer (e.g., the computer 30 of FIG. 1). The system further comprises a GUI 206 via which information is presented to the non-expert user (i.e., a layman marketing campaign designer, such as a store or small business owner or the like), and via which the user enters information to the system. The GUI 206 may also be integral to the computer 30.

The memory persistently stores data and computer-executable instructions for performing the described functions, methods, techniques, and the like. For instance, the memory 208 stores a campaign creation wizard module that is executed by the processor to receive information from the user, analyze received information, and output the business logic for a marketing campaign for to the user. In this manner, the wizard module 208 walks the non-expert user through the campaign design process in order to generate the business logic for the marketing campaign that targets the user's customers with personalized campaign documents 209 (e.g., post cards, mailers, emails, web-based ads, or any other suitable campaign media.

As stated above, the system 200 comprises the processor 202 that executes, and the memory 204 that stores one or more computer-executable modules (e.g., programs, computer-executable instructions, etc.) for performing the various functions, methods, procedures, etc., described herein. Additionally, “module,” as used herein, denotes a set of computer-executable instructions, software code, program, routine, or other computer-executable means for performing the described function, or the like, as will be understood by those of skill in the art. Additionally, or alternatively, one or more of the functions described with regard to the modules herein may be performed manually.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

A knowledge-base 210 (i.e., a computer-readable medium) of VDP patterns 212 is pre-constructed, e.g., by a knowledge engineer, and provided to such a system. The VDP patterns are represented using the vocabulary of the non-expert. Additionally, given a starting knowledge-base, the VDP patterns are also amenable to extension by the campaign designer (non-expert), graphic artist, VDP logic developer, or other campaign developer.

The systems and methods described herein are supported by the wizard module 208, which can accept the campaign designer's desired campaign intent and automatically express and store the campaign intent as one or more instances of VDP patterns 212 and VDP elements 214 (see, e.g., FIGS. 2 and 3). The described systems and methods use an underlying infrastructure to transform the provided instances into initial VDP plan logic that can be used by the logic developer to create the final VDP plan logic. The plan logic incorporates the rules, data schema, and content objects exported to the design. This arrangement also provides the logic developer and/or data specialist with a skeleton of the information expected to be available in the data, and as such can “flag” early on data inconsistencies or shortcomings. Sufficiently simple campaign plan logic could be used to compose the campaign documents without need for a logic developer.

The campaign designer first expresses (e.g., via the GUI 206) the type of VDP campaign they would like to create. This can occur in various ways. For instance, one approach is that all VDP patterns 212 stored in the knowledge-base 210 are presented to the campaign designer for them to choose from. To help select and instantiate a VDP pattern, the campaign designer may be presented with one or more examples in the form of a natural language (NL) sentence. The scope of the natural language used in this embodiment corresponds to the vocabulary of the VDP patterns, which represents the knowledge of the non-expert. Sentence examples may include, without limitation:
I want to send out a promotion to my new health club service.
I want to send out a recall notice for a specific tire model.
I want to send out notifications that a car warranty is expiring.
I want to send out (event) invitations to my family for a 50th wedding anniversary.
I want to up-sell my top customers by offering a variable discount on a new TV on their birthday.
I want to send out an announcement that my business is moving to a new location.
I want to send an (open) invitation for people to join my stamp collecting club.
I want to send out an advertisement to my customers announcing that we carry new finishing butters.
I want to send out customer satisfaction surveys to recent car repair clients.
I want to send personalized holiday greeting cards to all of my friends.

Each VDP pattern 212 is supported by a natural language description that consists of all high-level VDP elements 214 associated with that VDP pattern. The associated VDP elements are “parameterizable” pieces of the NL description. Some examples include:

Product Offer:
For each recipient, my Product Offer will promote <Product> by offering <Reward> if the recipient takes <Call To Action>, with possible <Restrictions>.

Announcement:
For each customer, my Announcement will convey new <Information> with the <Benefit> to the customer with a possible <Call To Action>

Event Invitation:
My Event Invitation will invite each invitee to <Event> at designated <Venue> at a particular <Time> with a desired <Call To Action>, with possible <Restrictions>.

Each VDP element parameter (shown above in brackets < >) is provided as a semantic placeholder for the user to define VDP content. The campaign designer selects the VDP element from the sentence and may then enter any number of options to use as VDP content. For example, a pet store campaign designer selects the <Product> concept and inputs to the system the following product descriptions:

Iams Hairball-Control Cat Food
Flexi Retractable Dog Leash
Habitrail Hamster Habitat
BioCube Aquarium

Each product description is automatically created as a product instance in the knowledge-base of VDP patterns. In cases where multiple values are entered, it is inferred that the VDP element “Product” is variable content, and that a rule is desirable to determine which specific product description to use for each recipient. The campaign designer is then requested to enter the semantics of the data source that will determine the variable content of product for a particular recipient. To further the present example, the campaign designer specifies “pet preference” and assigns data values “cat,” “dog,” “hamster,” and “fish,” respectively. The “Product” VDP element in this case is denoted as “variable” in the knowledge base and each instance of the Product is tagged with the data value that is used to select it as variable content.

The data value may be implicit or explicit, and may come from any number of sources. Examples of data value extraction sources include, without limitation: the value may come from a database expert who mines customer purchase history to determine “pet preference’; from a specific pre-existing data field available in a data source; or from automated techniques for determining available data implicit in a given data source.

Continuing the example, the campaign designer selects the <Reward> concept and is offered choices for the type of Reward such as a Frequent-Buyer-Based Discount. The designer may then choose to vary such a discount based on the amount of purchases (e.g., number of purchases, total amount spent on all purchases, etc.) for the past predetermined period (e.g., 12-months). Variable rewards are specified of e.g. “30%”, “20%”, and “10%” and are offered to customers who have specified “spend level” of values e.g. “over $1000”, “between $500 and $1000”, and “less than $500” respectively. The Reward VDP element of Product Offer in the knowledge base is then denoted as “variable” and instantiated with these values, as was done for the Product VDP element above.

In a related example, the campaign designer wants the Call To Action element to be the same for all customers. The designer selects the <Call To Action> concept and enters a single value of “Redeem this offer at our store before June 30^{th}” The Call To Action VDP element in the knowledge base is set to “static” and instantiated with a single value. It will be appreciated that any VDP Pattern can be extended to include additional Promotional Messages, whether they are text or images. One option that the campaign designer may select is to include variable or static Promotional Messages in the VDP document. Continuing with the above pet store example, the campaign designer may provide various sets of graphic assets that they will use to provide an attractive marketing “feel” or aesthetic quality to the campaign document.

In some instances, the designer may desire to reuse the “pet preference” semantic data in which he desires to use imagery from a “cat” graphic asset folder or database when the pet preference is “cat”, a “dog” graphic asset folder when the pet preference is “dog,” etc. The graphic assets can also be pulled from a content management system that is connected to the wizard application. The designer can also specify variable text messages that include testimonials from cat-owners for the “cat” pet preference, testimonials from dog-owners for the “dog” pet preference, etc.

Once the knowledge base is populated with all desired instances that represent the campaign for a particular VDP pattern, the full instantiation of the campaign is then transformed into a partially-populated or, in some cases, a fully-executable, VDP plan. The transformation automatically creates all the content objects, the logic for determining the variable content, and the data schema needed to support the campaign plan, as well as stores the graphic asset files so they are accessible by the VDP environment. In a specific example in which Xerox's XMPie™ suite is employed, this feature creates an XMPie plan file for the uPlan™ logic definition application.

The VDP elements in the knowledge base may also contain various attributes 216 specific to a given element. For instance, a Product element may have single- and multi-valued attributes such as “price,” “image,” universal product code or “UPC,” etc. In one embodiment, a means for the campaign designer to specify values for the attributes of a VDP element is provided. The attribute values for the element are then made available as content when the corresponding VDP element is selected for a particular dynamic document. In one embodiment, the campaign designer downloads or otherwise generates a product data source 218 (e.g., a list, spreadsheet, or other data source comprising information relating to the products to be included on the campaign documents).

For instance, as the campaign designer is inputting the <Products> for the pet store campaign, he can specify a price and an image of each Product that is to appear on the marketing documents. In one example, upon entering the Product description, the campaign designer indicates a price and image that the product (e.g., a hamster habitat) will have, as associated attribute values. When providing associated values, known values are encoded directly into the knowledge base associated with the <Product> instance. Additionally or alternatively, an attribute value lookup is performed to identify the associated attribute value(s). In another embodiment, the associated value is initially left blank for later value assignment. A VDP element's attributes list may be obtained through various means with the GUI. Entries are made in the knowledge base that capture the campaign intent that the selected attributes represent variable content, as well as whether the selected attributes are graphics or text.

Continuing with the example, the campaign designer specifies known <Product> attribute values using the methods described herein. Table 1 shows examples of product attribute values 216, such as can be extracted from the product data source 218 by the processor 202 when executing the wizard 208, and/or entered directly by the campaign designer.

TABLE 1

| Product | Price | Image | UPC |
|---|---|---|---|
| Hairball Control | $30 | Image1.jpeg | 019014230079 |
| Food | | | |
| Retractable Dog | $20 | Image2.TIFF | 047181025019 |
| Leash | | | |
| Hamster Habitat | $25 | Image3.GIF | 080605626003 |
| Aquarium | $80 | Image4.PNG | 797926820514 |

The wizard 208 employs campaign intent that may include references to images. It will be appreciated by those of skill that any suitable image type or format may be employed by the subject systems and methods. While Table 1 illustrates four image file formats (jpeg, TIFF, GIF, and PNG), it will be understood that the herein-described systems are not limited thereto.

If the campaign designer desires the recipient's first name to appear on the dynamic document, then the designer indicates that they want the ‘firstName’ of the recipient to be variable and designate the assignment be to set up by a data specialist. The data specialist and/or logic developer then use this designer-specified campaign intent knowledge to modify the automatically created plan file to extract the appropriate value for the recipient's first name out of a recipient data source 220, which may be provided by the designer (e.g., a spreadsheet comprising a list of the designer's customers or a subset thereof, a database, a comma-delimited list of customers, etc.).

The knowledge base 210 also includes graphic assets 222 (e.g., images, icons, logos, etc.), that the user can select to personalize the campaign documents. Additionally, the expert suggestions are stored in the knowledge base and can be retrieved and presented to the user when the wizard determines that the user's VDP pattern can benefit from automatic suggestions of meaningful actions for the user to take. Additionally, the knowledge base 210 includes a data source auto-categorization module 226 that automatically determines the semantic categories of the data values (e.g., first name, last name, zip code, spend level, pet type, etc.) in each column or row of a downloaded data source. An example of a data source auto-categorization technique that may be employed in conjunction with various aspects described herein is found in U.S. patent application Ser. No. 12/857,997, filed on Aug. 17, 2010 and entitled “Semantic Classification of Variable Data Campaign Information,” which is hereby incorporated by reference herein in its entirety. An automated campaign validation module 228 continuously or periodically checks the campaign pattern during the design states for errors. If an error is detected, the wizard application prompts the user to correct the errors and walk the user through the corrective actions.

FIG. 5-23 and the related description illustrate an example in which a campaign designer or user is walked through the campaign creation process by the campaign creation wizard 208 of FIG. 4 (e.g., which is executed by the processor 202 and presented to the user on the GUI 206 or the like) to generate the business logic for a marketing campaign that generates and provides personalized advertisements or offers to customers in the user's customer list.

With continued reference to the preceding Figures, FIG. 5 shows a screenshot of an example advertisement 300 or offer that is presented to a recipient by a pet store merchant or proprietor. Variable data (e.g., recipient names, spend levels, pet preference, pet names, etc.), is extracted from a recipient data source such as a spread sheet or the like maintained by the merchant or proprietor offering the product. An example of a recipient data source, such as the recipient data source 220 of FIG. 4, is shown in Table 2.

TABLE 2

| | | | Customer | Customer | | |
|---|---|---|---|---|---|---|
| | First | | Spend | Pet | Customer | |
| ID | Name | Last Name | Level | Preference | Pet Name | Zip Code |
| 1 | Michael | Shepherd | 720 | fish | | 10005 |
| 2 | Kirk | Ocke | 260 | dog | | 90212 |
| 3 | Dale | Gaucas | 405 | cat | | 60622 |
| 4 | Lee | Moore | 210 | hamster | Cotton | 60625 |
| 5 | Barry | Gombert | 450 | bird | | 10011 |
| 6 | Karen | Braun | 660 | dog | Fido | 91230 |
| 7 | Al | Coté | 850 | fish | | 60623 |
| 8 | Mike | Kehoe | 65 | bird | | 90210 |
| 9 | Mohit | Seth | 155 | hamster | | 10018 |

The ad 300 includes several variable data fields that have been populated using the described wizard application. For instance, a recipient's name 302 is personalized, and a personalized discount 304 is also presented in the advertisement. In the illustrated example, the first recipient has a first name of “Michael,” has a pet fish, and has a high spend level relative to other recipients in the data source. Since it is known from data provided by the marketing campaign designer (i.e., the merchant or proprietor of the store, or the like) that the particular recipient keeps pet fish, a pet image 306 of goldfish is included in the personalized advertisement. Additionally, since the recipient is known to have a pet fish, an aquarium is selected as a potential product for sale, and an image 308 of the product is presented on the ad 300. The product name 310 is also presented, along with the product price 312 (the discounted price and the original price, which is also variable as a function of the given recipient's spend level, customer status level, etc.)

In one example, the product data source includes information related to product identity and price, as shown in Table 3.

TABLE 3

| Product | | | |
|---|---|---|---|
| Name | Product Price | Product Quantity | Customer Rating |
| Iams Cat | $26 | 45 | 4.8 stars |
| Food | | | |
| Flexi Dog | $15 | 63 | 4.5 stars |
| Leash | | | |
| Habitrail | $50 | 12 | 4.3 stars |
| Habitat | | | |
| BioCube | $80 | 8 | 4.5 stars |
| Aquarium | | | |
| Nutriphase | $19 | 22 | 4.1 stars |
| Bird Food | | | |

The system thus applies the discount (i.e., 30% in the example of FIG. 5), which is variable as a function of the particular recipient, to the original price (i.e., $80) to calculate the discounted price (i.e., $56 in this example), which is also presented in the advertisement. Additionally, the advertisement includes a call to action 314 in the form of an “purchase-before” date (e.g., an expiration date for the offer).

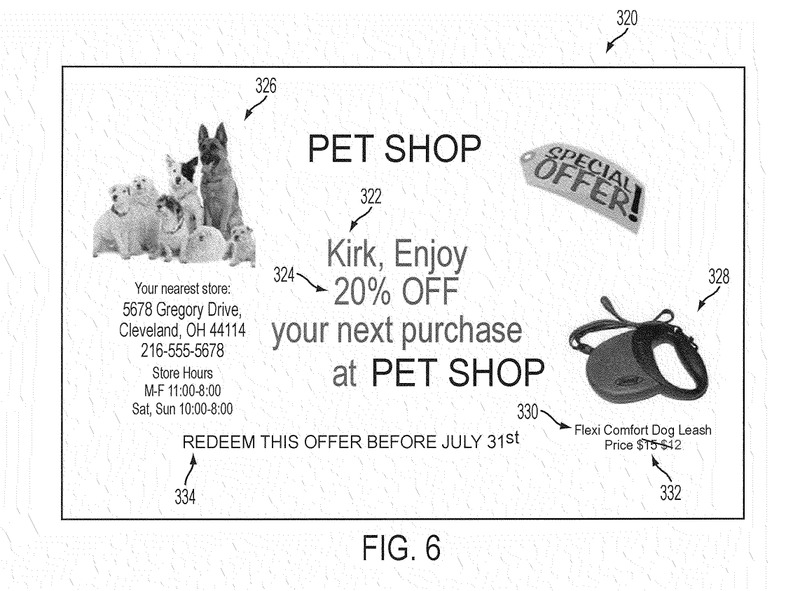

FIG. 6 shows a screenshot of an example advertisement 320 or offer that is presented to a second recipient by the pet store merchant or proprietor. The second recipient's first name 322 is displayed in the advertisement. In the example shown in

FIG. 6, the second recipient has a lower spend level, as seen in Table 2. Therefore, the second recipient is offered a smaller discount 324 (i.e., 20% in this example). Additionally, as seen in Table 2, the second recipient keeps a dog as a pet. Therefore, the pet image 326, product image 328, and product name 330 all relate to dogs and/or products for dogs. Additionally, the advertisement 320 includes a discounted price 332 that reflects the 20%, which is applied to the original purchase price of $152. Finally, the advertisement includes a call to action 334 in the form of an “purchase-before” date (e.g., an expiration date for the offer).

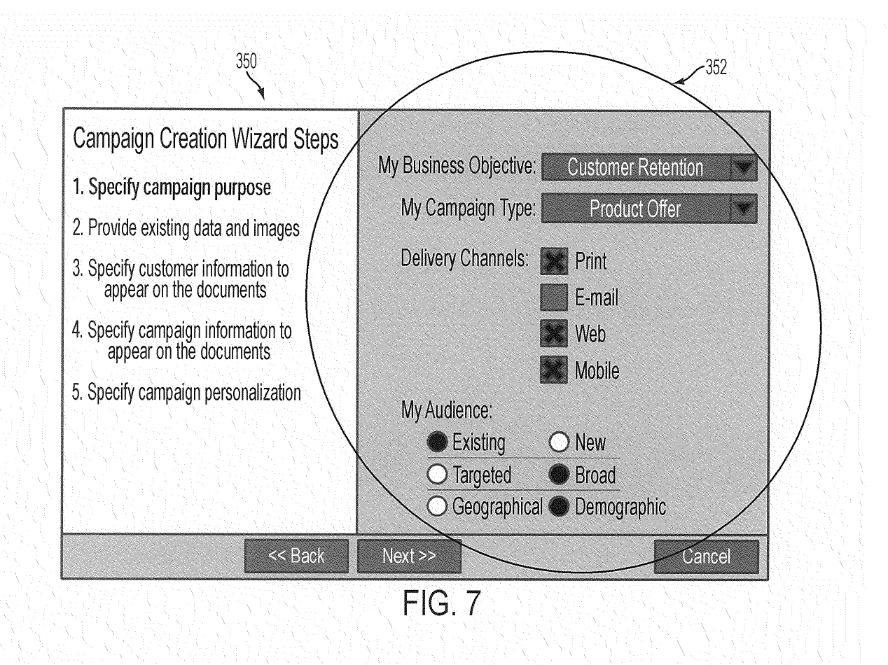

FIG. 7 illustrates a screenshot 350 of a screen presented to a user (i.e., a campaign designer) during campaign creation when the wizard application is being executed, in accordance with one or more aspects described herein. The screenshot 350 illustrates a first stage of campaign creation, in which a user enters intent information 352 including but not limited to a business objective, a campaign type, delivery channels, and type of audience to be used to deliver the advertisements. In the illustrated example, a user has selected “customer retention” as a business objective, and “product offer” as a campaign type. Other types of business objectives that can be selected include “brand awareness”, “lead generation”, and “customer acquisition”. The user has also chosen to send the advertisements by printed mail, mobile device, and over the Internet as web-based advertisements. The user-specified campaign intent information 352 is employed to identify a pre-generated VDP pattern that suits the user's needs.

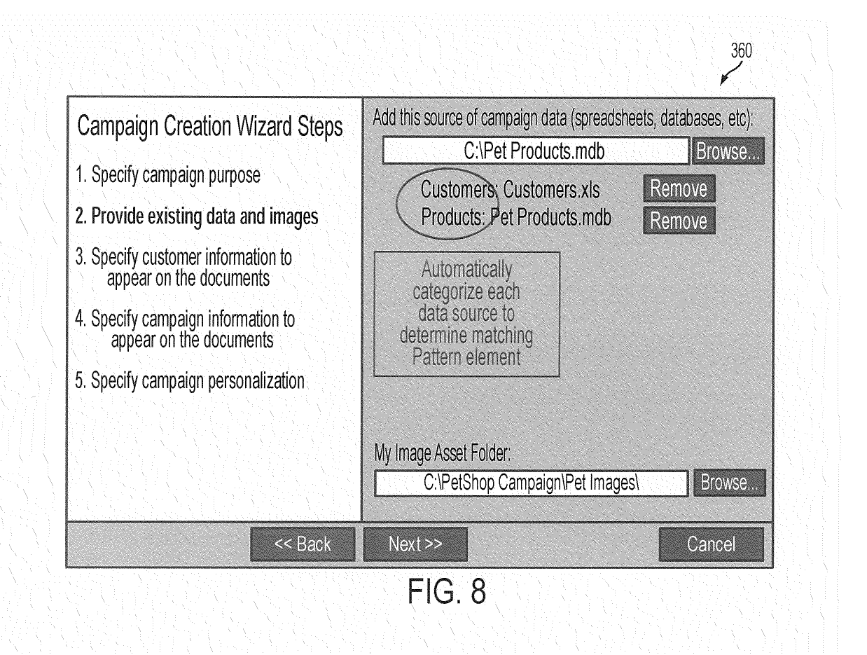

FIG. 8 shows a screenshot 360 of a screen presented to a user during campaign creation when the wizard application is being executed, in accordance with one or more aspects described herein. At this stage of campaign development, the user specifies data sources (e.g., a customer list and a product list) that are analyzed and/or used to extract information in order to automatically categorize each data source and to determine corresponding VDP pattern elements.

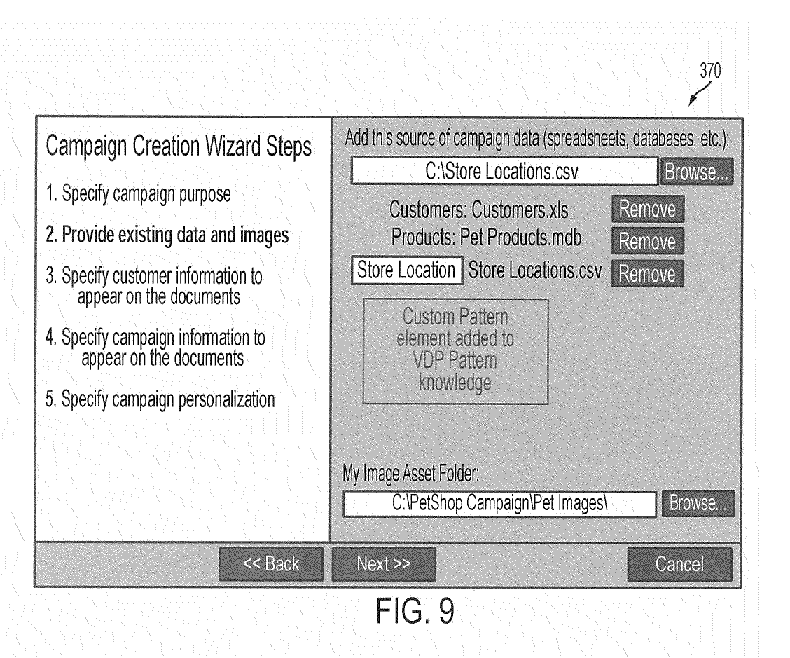

FIG. 9 shows a screenshot 370 from the campaign creation wizard in which the user identifies a list of store locations that can be used to determine which store location is closest to the recipient's residence or other address on file. In this manner, a custom pattern element is added to the VDP pattern.

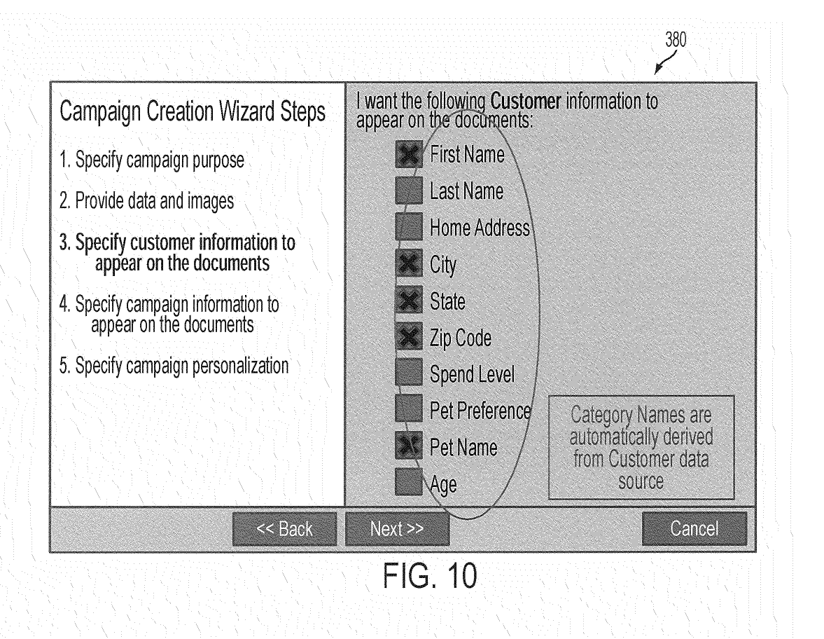

FIG. 10 shows a screenshot 380 from the campaign creation wizard in which the user identifies customer information that the user desires to have displayed in the campaign documents. In the illustrated example, the user has selected first name, city, state, zip code, and pet name.

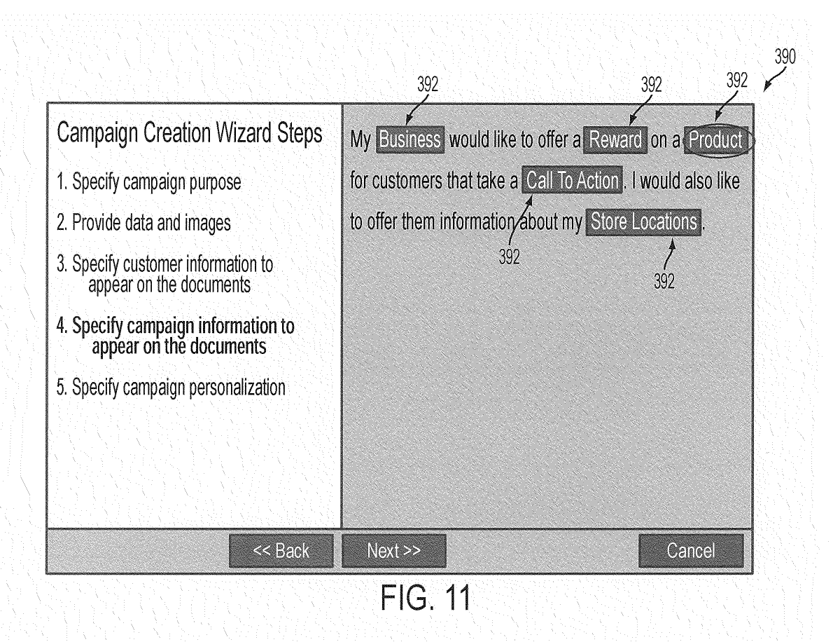

FIG. 11 shows a screenshot 390 from the campaign creation wizard in which the user is presented with a number of selectable fields 392 that can be selected to enter additional information. In the illustrated example, the user has selected the “product” button.

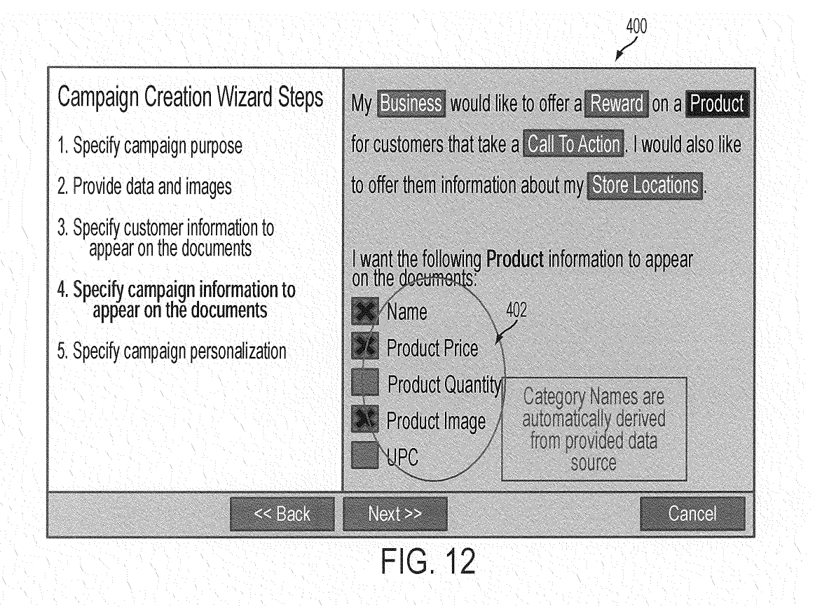

FIG. 12 shows a screenshot 400 from the campaign creation wizard in which the user is presented with a number of selectable product parameters 402 related to product information to be displayed on the campaign document after selecting the “product” button on the screen 390 of FIG. 11. In the illustrated example, the user has selected product name, product price, and product image as parameters to be displayed for the selected product.

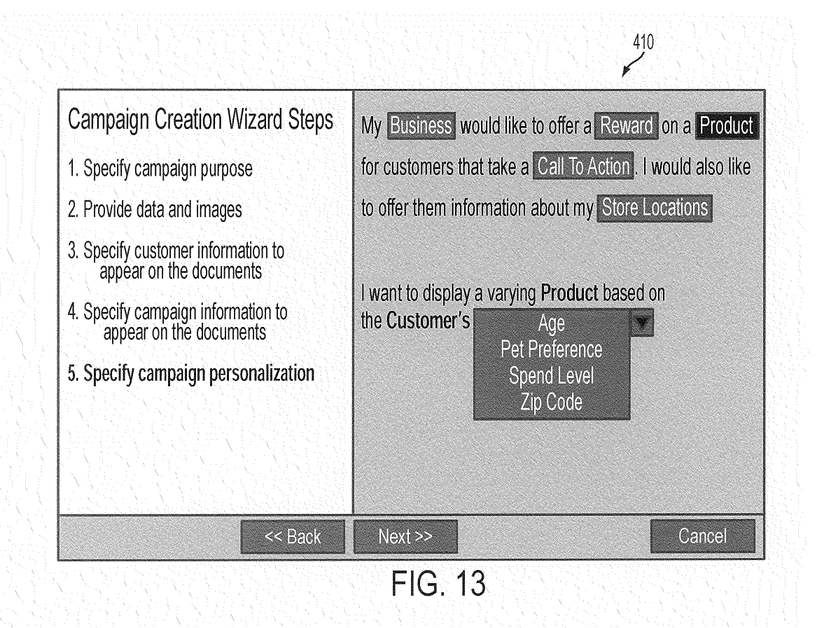

FIG. 13 shows a screenshot 410 from the campaign creation wizard in which the user is presented with a number of selectable customer parameters that are employed by the wizard application to vary products offered to customers listed in the recipient data source (see, e.g., Table 2). In the illustrated example, the user has the option of varying a product that is offered to a customer as a function of customer age, pet preference, spend level, and zip code.

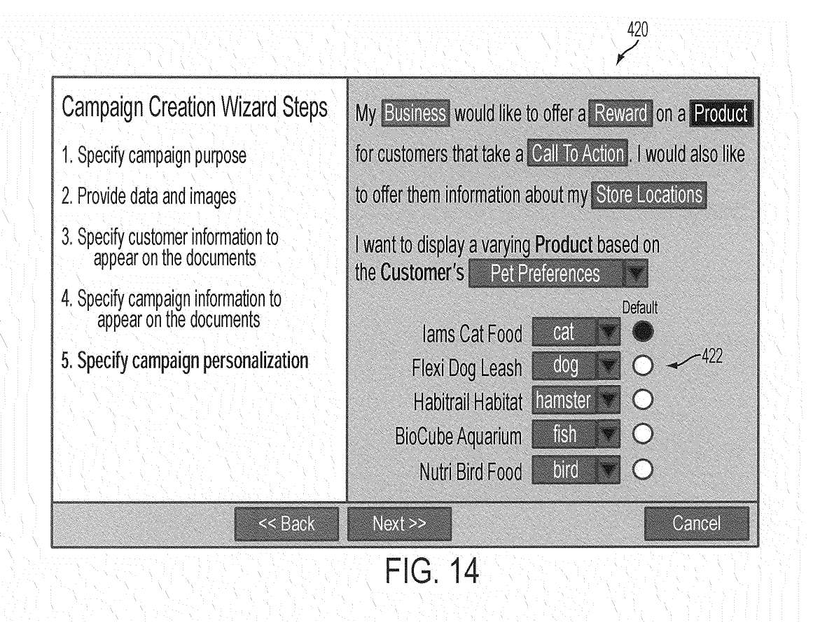

FIG. 14 shows a screenshot 420 from the campaign creation wizard in which the user has selected “pet preference” as a parameter by which to vary product offerings among different customers. In this example, the user is then presented with a number of selectable fields 422 that can be selected to enter additional information.

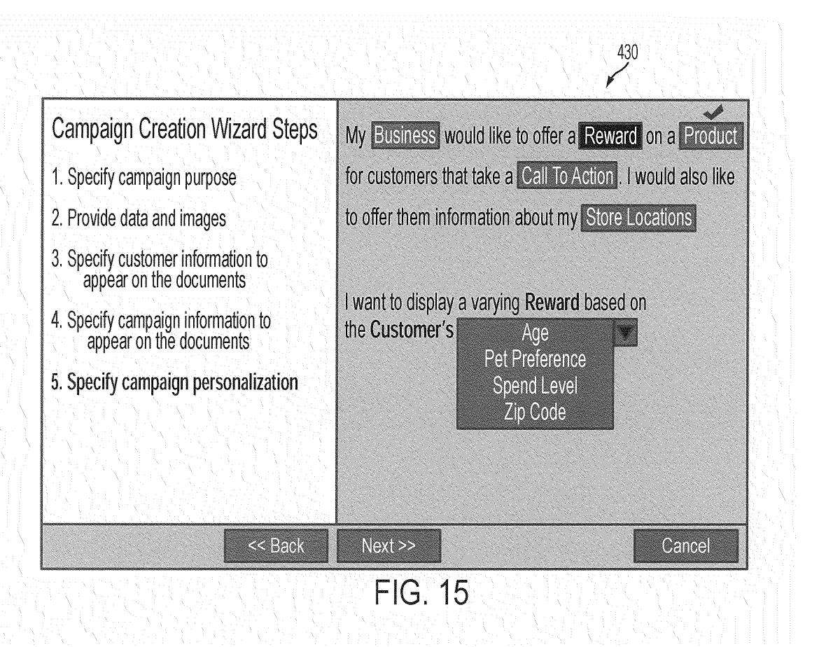

FIG. 15 shows a screenshot 430 from the campaign creation wizard in which the user is presented with a number of selectable parameters that are employed by the wizard application to vary rewards offered to customers listed in the recipient data source (see, e.g., Table 2). In the illustrated example, the user has the option of varying a reward that is offered to a customer as a function of customer age, pet preference, spend level, and zip code.

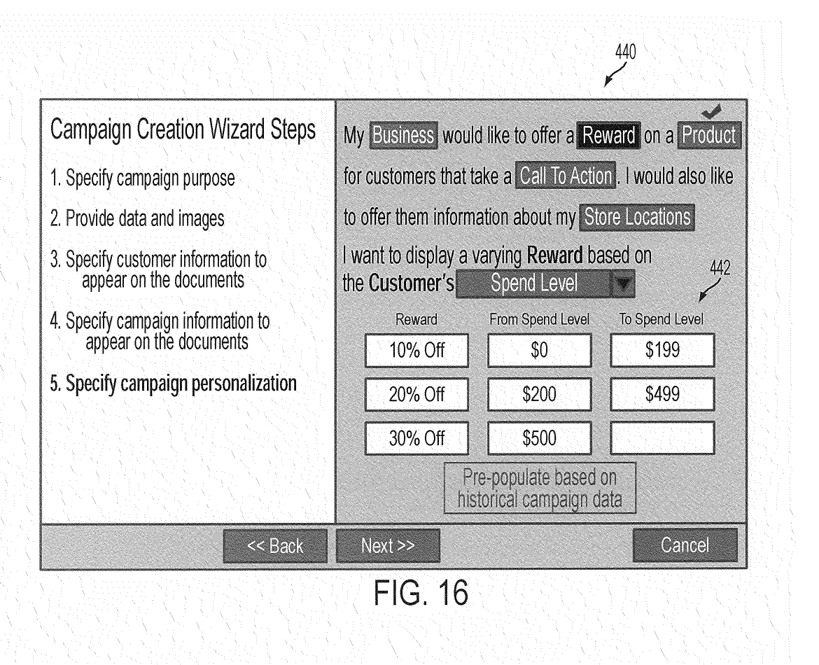

FIG. 16 shows a screenshot 440 from the campaign creation wizard in which the user has selected “spend level” as a parameter by which to vary reward offerings among different customers. In this example, the user is then presented with a number of fields 442 that can be populated with additional reward information.

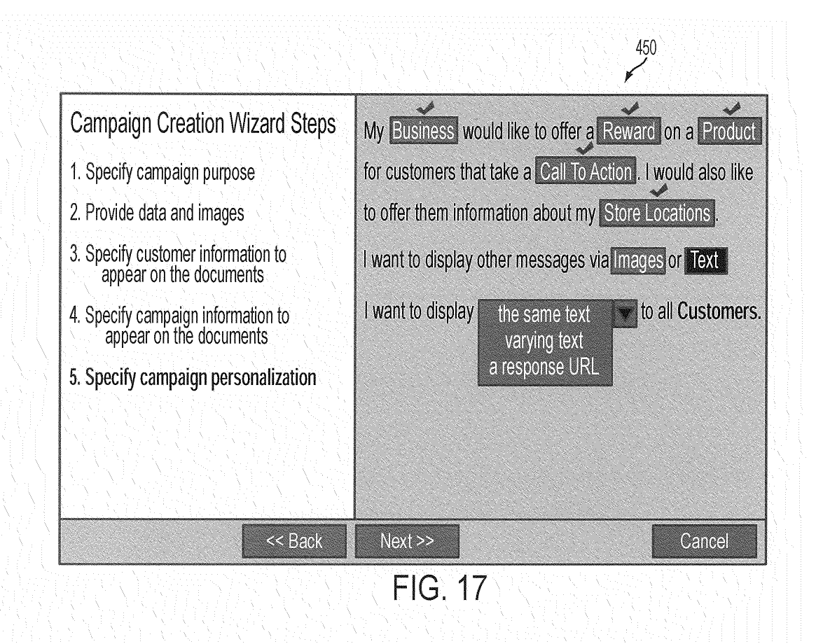

FIG. 17 shows a screenshot 450 from the campaign creation wizard in which the user is presented with a number of selectable options for displaying text and/or a website address to customers listed in the recipient data source (see, e.g., Table 2). In the illustrated example, the user has the option of displaying varying text, common text, or a response universal resource location (URL) to all customers.

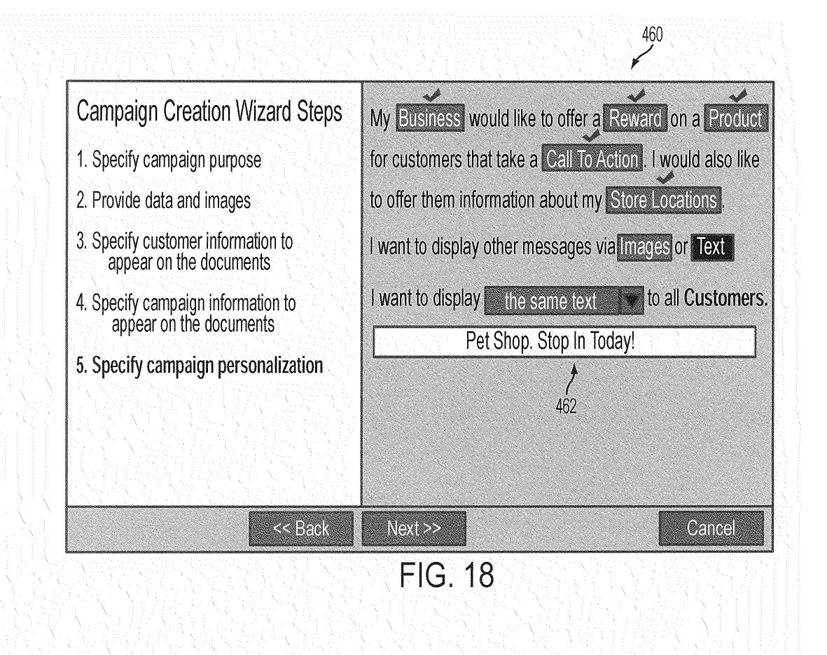

FIG. 18 shows a screenshot 460 from the campaign creation wizard in which the user has selected to display common text to all customers, and has entered the text in a designated field 462.

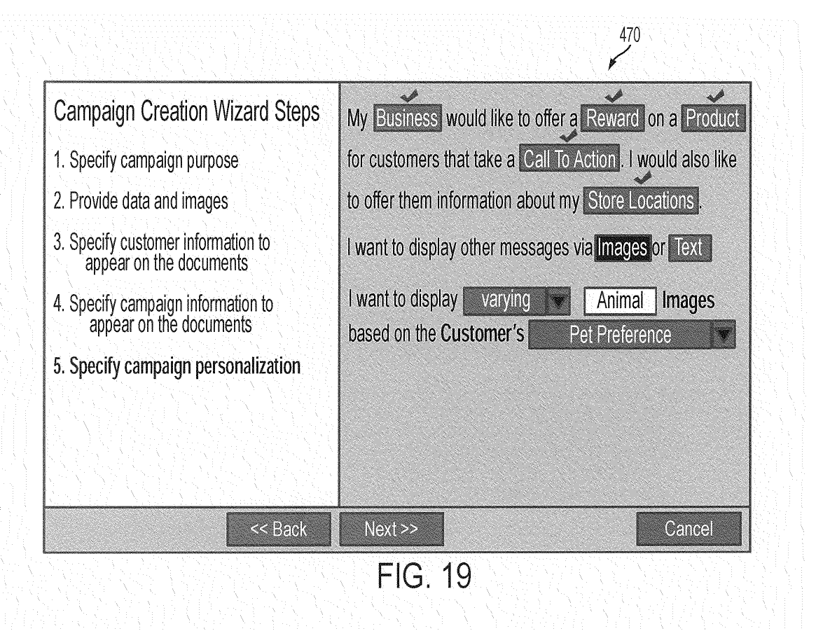

FIG. 19 shows a screenshot 470 from the campaign creation wizard in which the user has selected to display varying animal images to different customers, based on the customers pet preference.

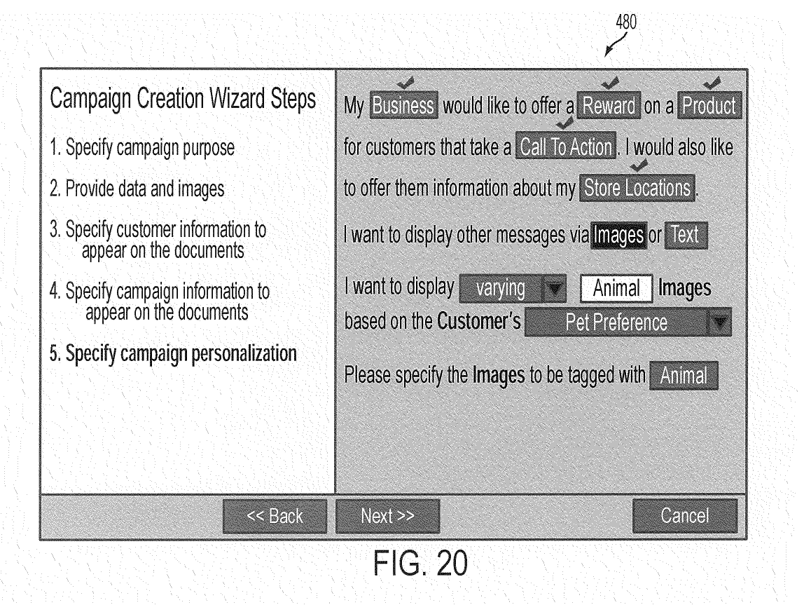

FIG. 20 shows a screenshot 480 from the campaign creation wizard in which the user is prompted to specify the images that are to be tagged with the metatag “Animal.”

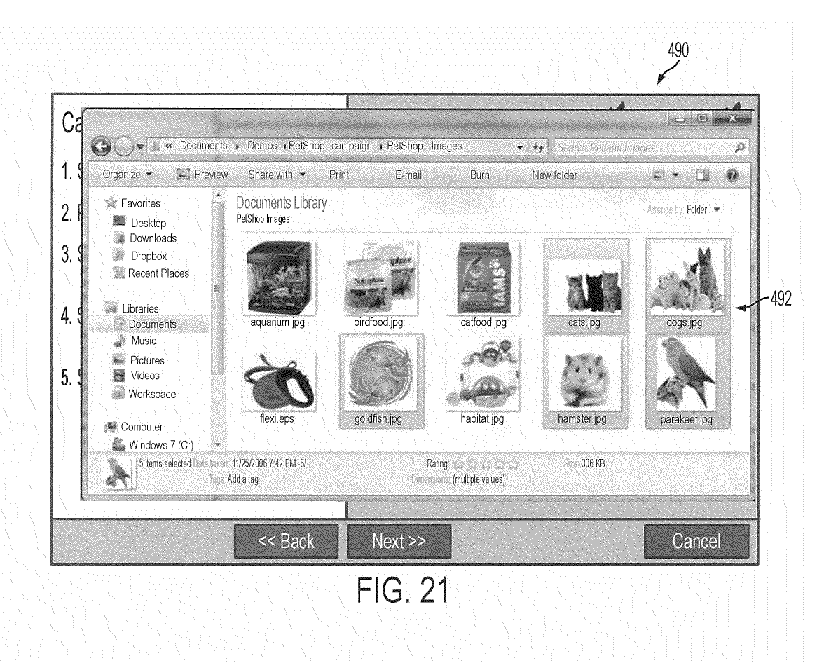

FIG. 21 shows a screenshot 490 from the campaign creation wizard in which the user is presented with a number of selectable images 492 for presenting to customers listed in the recipient data source (see, e.g., Table 2).

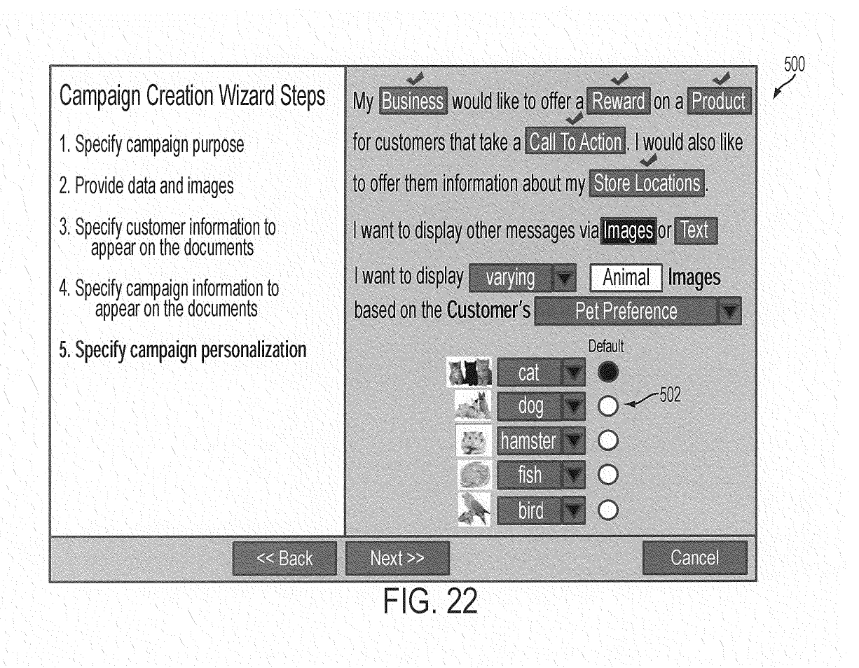

FIG. 22 shows a screenshot 500 from the campaign creation wizard in which the user is presented with a number of selectable default animal type images 502 to be presented to customers listed in the recipient data source (see, e.g., Table 2). In the illustrated example, the user has selected a cat image to be displayed as the default image.

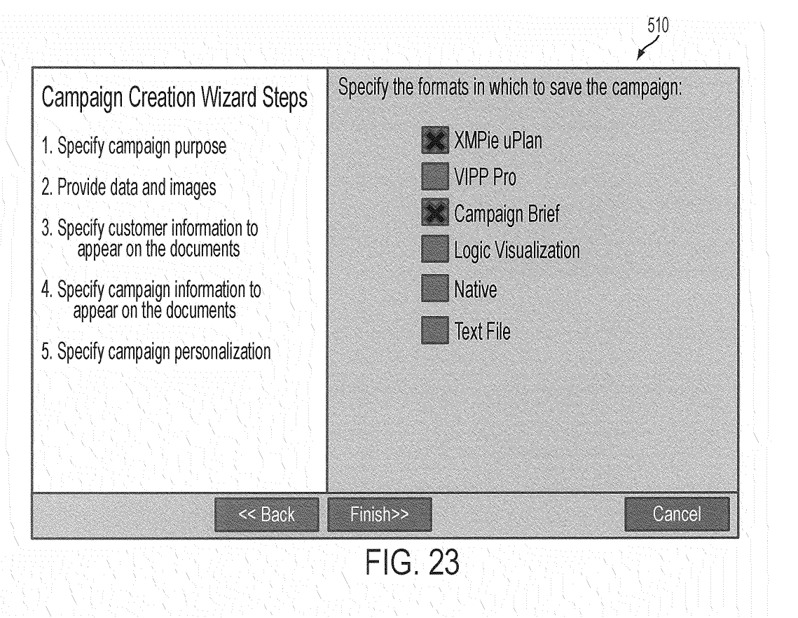

FIG. 23 shows a screenshot 510 from the campaign creation wizard in which the user is prompted to specify formats in which to save the marketing campaign. In the illustrated example, the user has selected to save the campaign as both an XMPie uPlan file and as a Campaign Brief file.

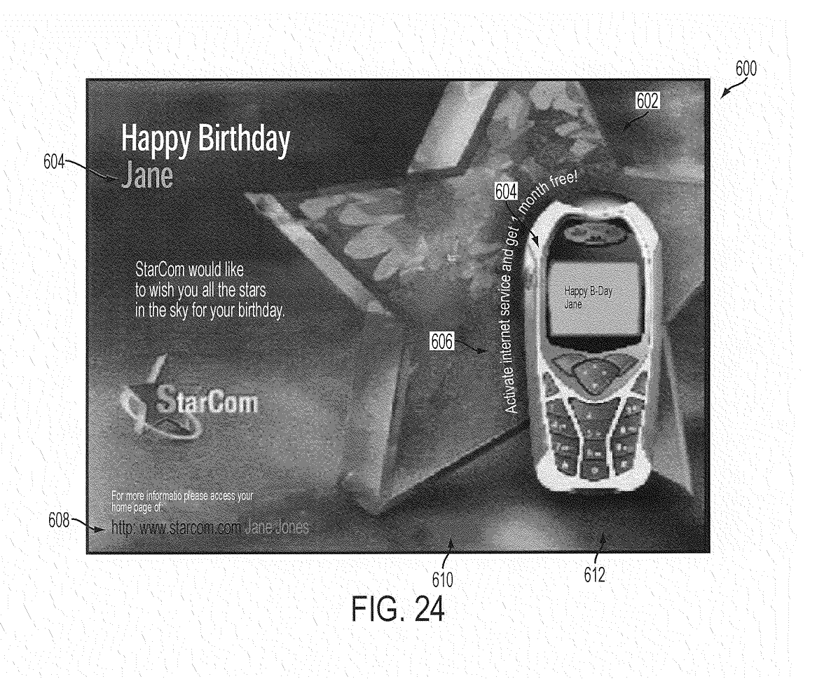

FIGS. 24-44 and the related description illustrate an example in which the user (e.g., a campaign designer for a cellular service provider, such as StarCom Inc., which is used by way of example herein to illustrate the herein-described aspects) interacts with the campaign creation wizard application to generate a marketing campaign in which the user's intended purpose is to generate a marketing campaign that offers customers in the user's database a discount on a good or service on their respective birthdays.

FIG. 24 illustrates a screenshot 600 of the possible document content produced from the business logic created by the campaign creation wizard in which the user has generated a campaign document 602 (e.g., a post card) that includes textual birthday wishes 604 for the recipient, an activation notice 606, a personalized URL 608 for the recipient, a background image 610, and an image of a cellular phone 612.

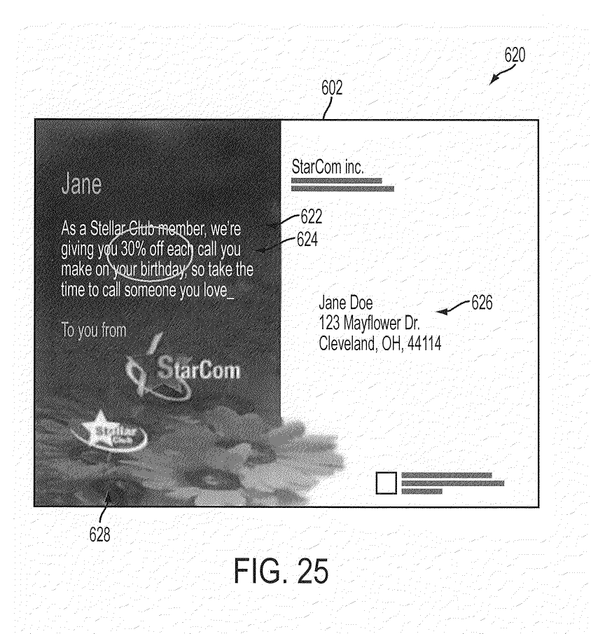

FIG. 25 shows a screenshot 620 of the possible document content produced from the business logic created by from the campaign creation wizard showing the back of the campaign document 602, which includes, inter alia, a promotional message 622, a discount amount 624, and the recipient's address 626, all of which are personalized to the recipient.

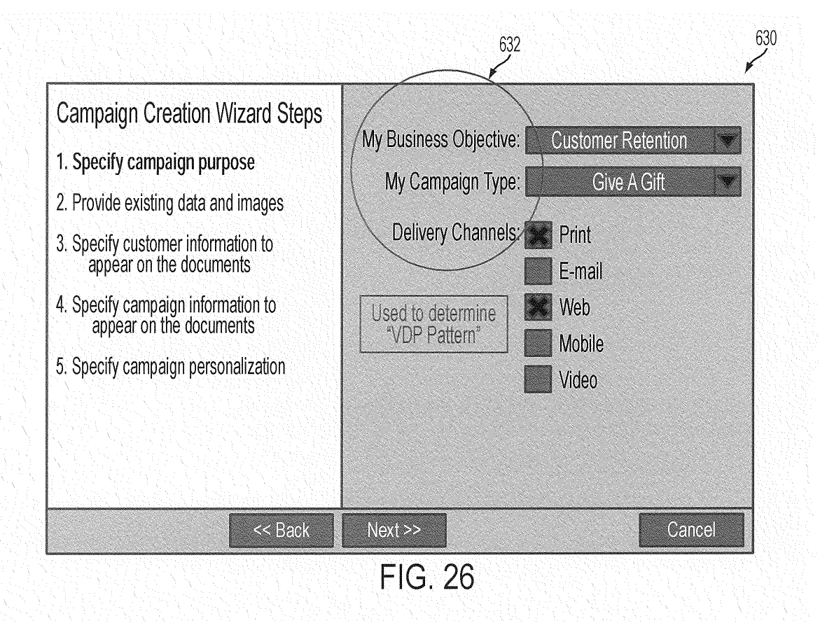

FIG. 26 illustrates a screenshot 630 of a screen presented to a user (i.e., a campaign designer) during campaign creation when the wizard application is being executed, in accordance with one or more aspects described herein. The screenshot 630 illustrates a first stage of campaign creation, in which a user enters intent information 632 including but not limited to a business objective, a campaign type, delivery channels, and type of audience to be used to deliver the advertisements. In the illustrated example, a user has selected “customer retention” as a business objective, and “Give a Gift” as a campaign type. The user has also chosen to send the advertisements by printed mail and over the Internet as web-based advertisements. The user-specified campaign intent information 632 is employed to identify a pre-generated VDP plan that suits the user's needs.

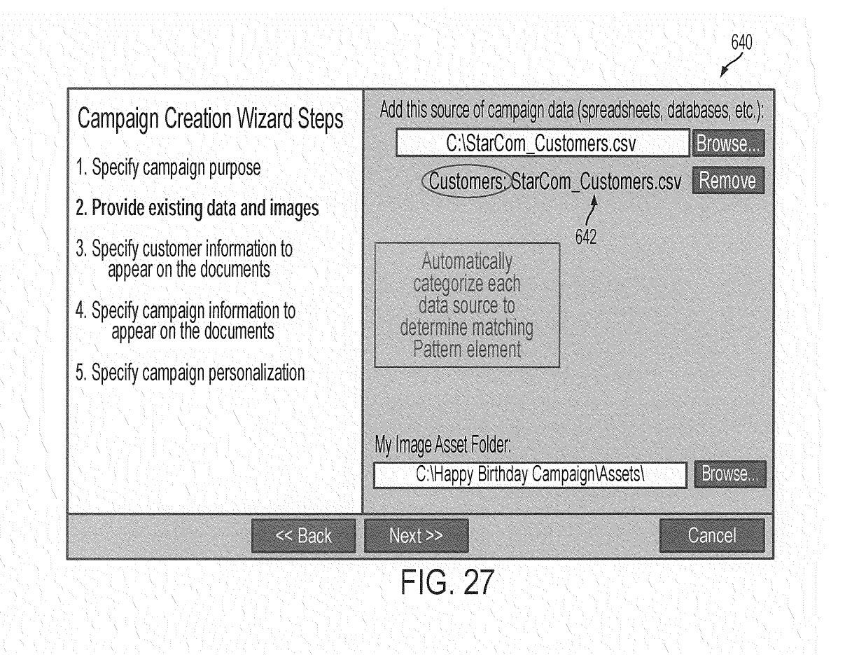

FIG. 27 shows a screenshot 640 of a screen presented to a user during campaign creation when the wizard application is being executed, in accordance with one or more aspects described herein. At this stage of campaign development, the user specifies data sources 642 (e.g., spreadsheets, databases, etc.; a customer list, a product list, etc.) that are analyzed and/or used to extract information in order to automatically categorize each data source and to determine corresponding VDP pattern elements.

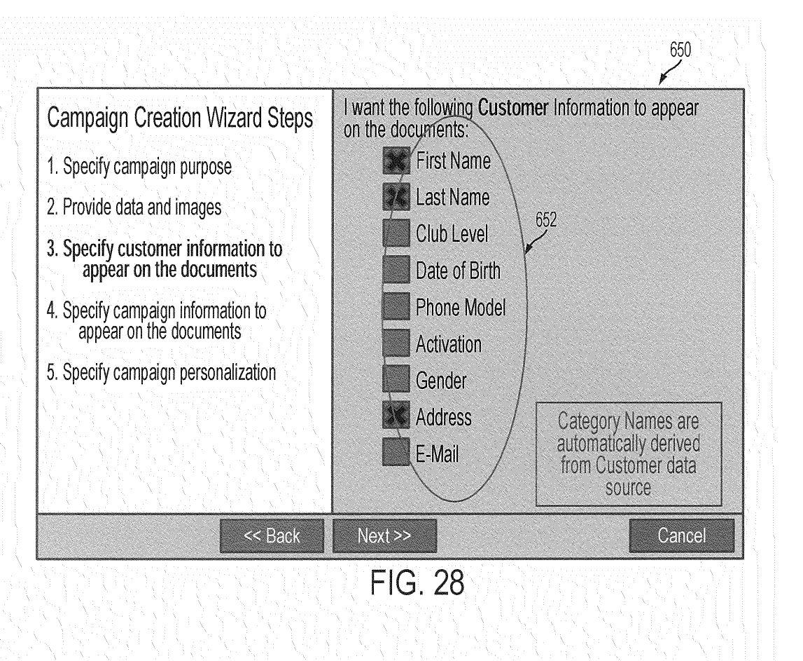

FIG. 28 shows a screenshot 650 from the campaign creation wizard in which the user identifies personal customer information 652 that the user desires to have displayed in the campaign documents. In the illustrated example, the user has selected first name, last name, and address.

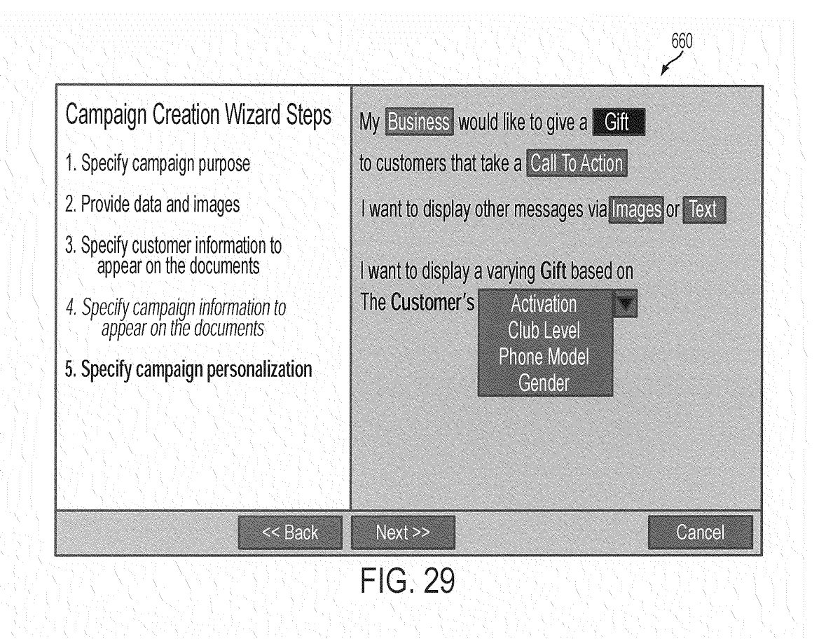

FIG. 29 shows a screenshot 660 from the campaign creation wizard in which the user is presented with a number of selectable parameters that are employed by the wizard application to vary gifts (i.e., discount amounts or the like) offered to customers listed in the recipient data source. In the illustrated example, the user has the option of varying a product that is offered to a customer as a function of activation, club level (i.e. customer status), phone model, and gender.

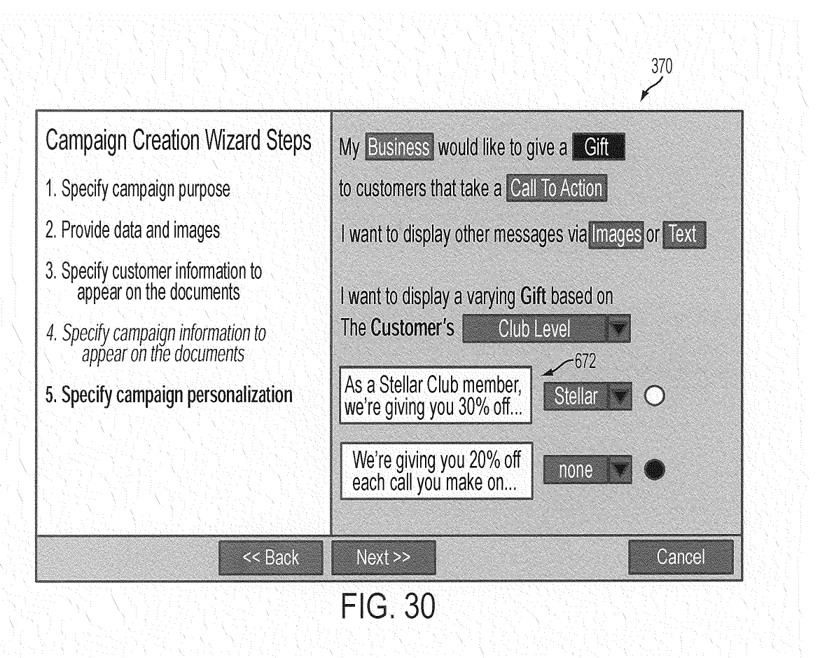

FIG. 30 shows a screenshot 670 from the campaign creation wizard in which the user has selected “club level” as a parameter by which to vary gift offerings among different customers. In this example, the user is then presented with a number of selectable and populatable fields 672 that can be selected and populated to enter additional information.

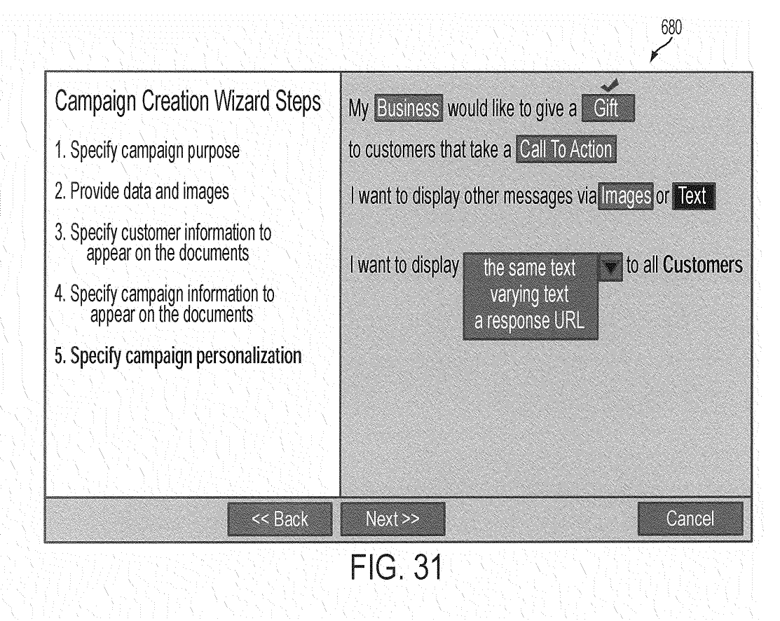

FIG. 31 shows a screenshot 680 from the campaign creation wizard in which the user is presented with a number of selectable options for displaying text and/or a website address to customers listed in the recipient data source. In the illustrated example, the user has the option of displaying varying text, common text, or a response universal resource location (URL) to all customers.

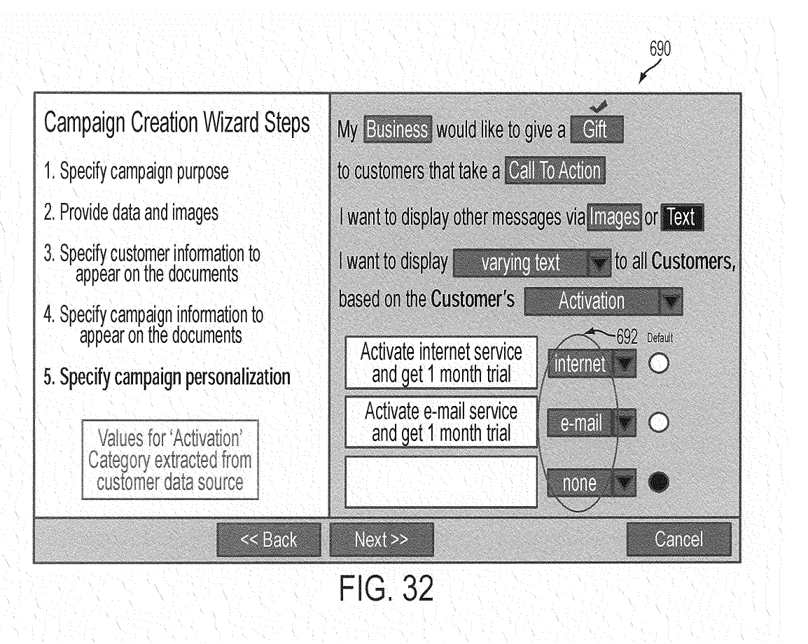

FIG. 32 shows a screenshot 690 from the campaign creation wizard in which the user has selected to display varying text to all customers based on the customers' activation of different services 692 (e.g., email, internet, etc.), and has entered the text in corresponding designated fields.

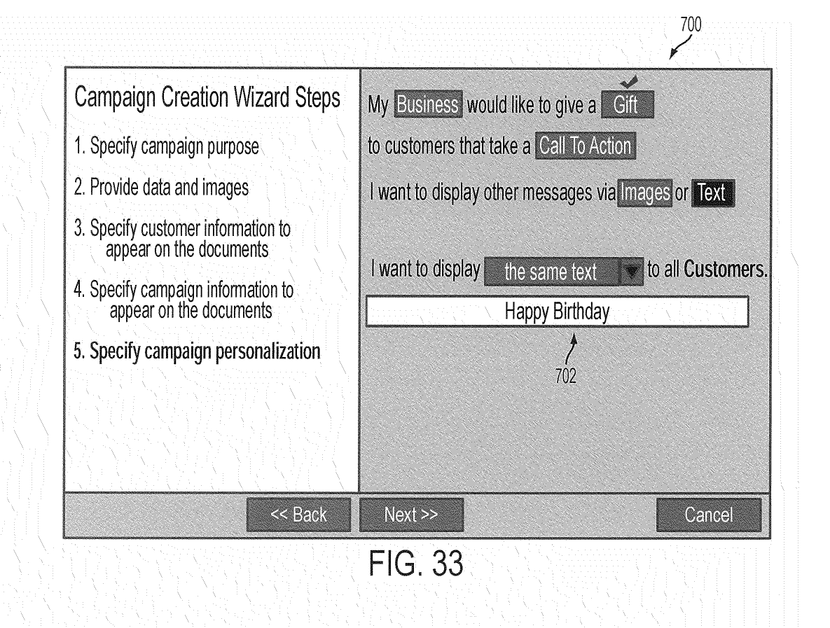

FIG. 33 shows a screenshot 700 from the campaign creation wizard in which the user has selected (e.g., by returning to the screen shown in FIG. 31) to display the same text to all customers, and has entered the text “Happy Birthday” in the corresponding designated field 702.

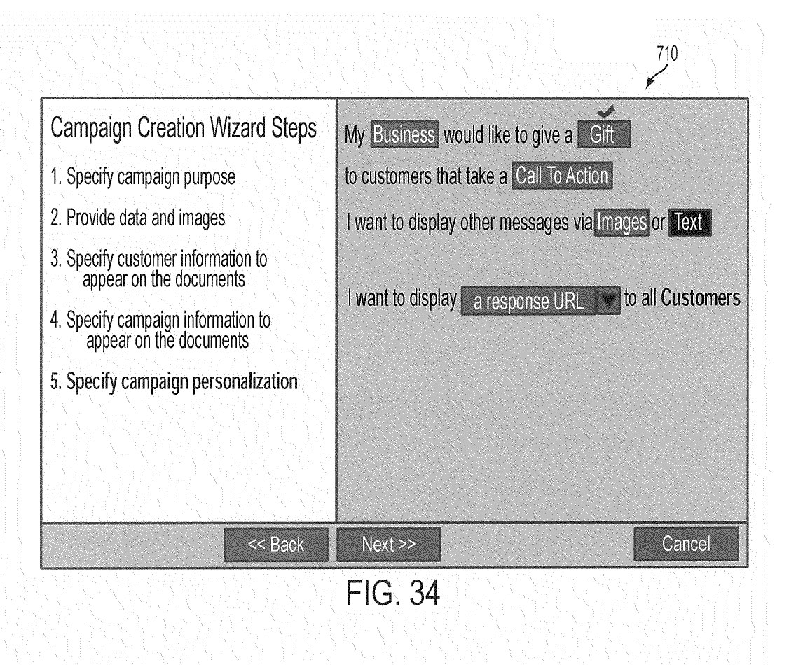

FIG. 34 shows a screenshot 710 from the campaign creation wizard in which the user has selected (e.g., by returning to the screen shown in FIG. 31) to display a response URL to all customers.

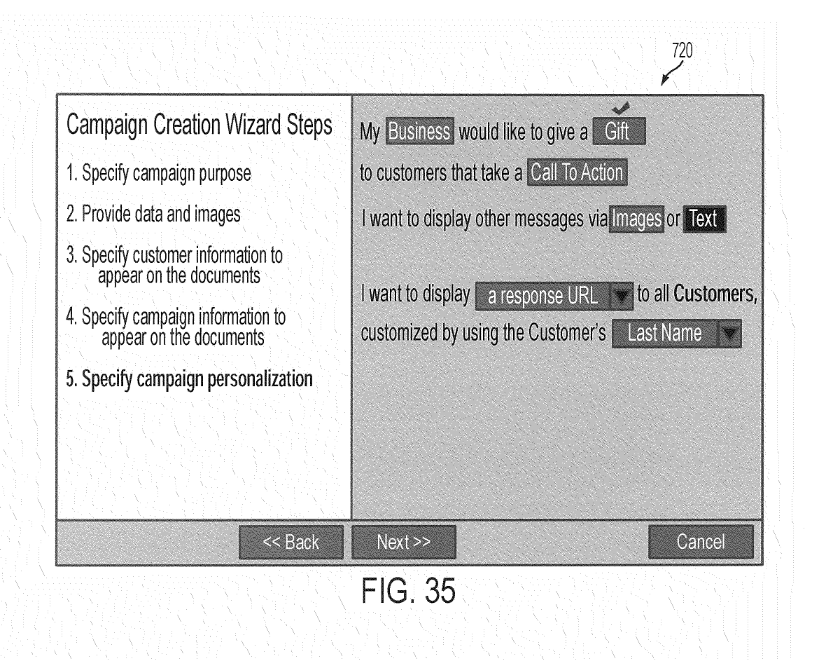

FIG. 35 shows a screenshot 720 from the campaign creation wizard in which the user has selected to customize the response URL as a function of recipients' respective last names.

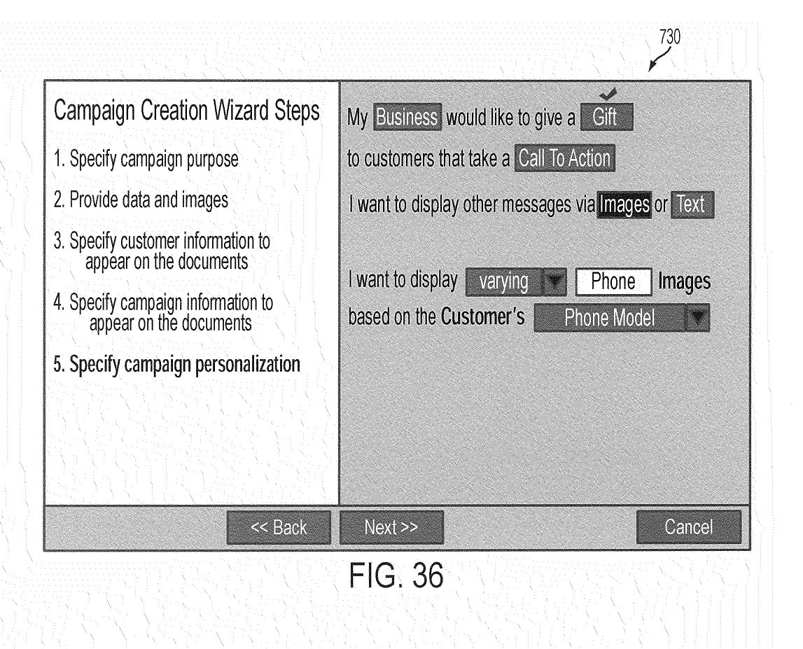

FIG. 36 shows a screenshot 730 from the campaign creation wizard in which the user has selected to display varying phone images based on the recipients' respective phone models.

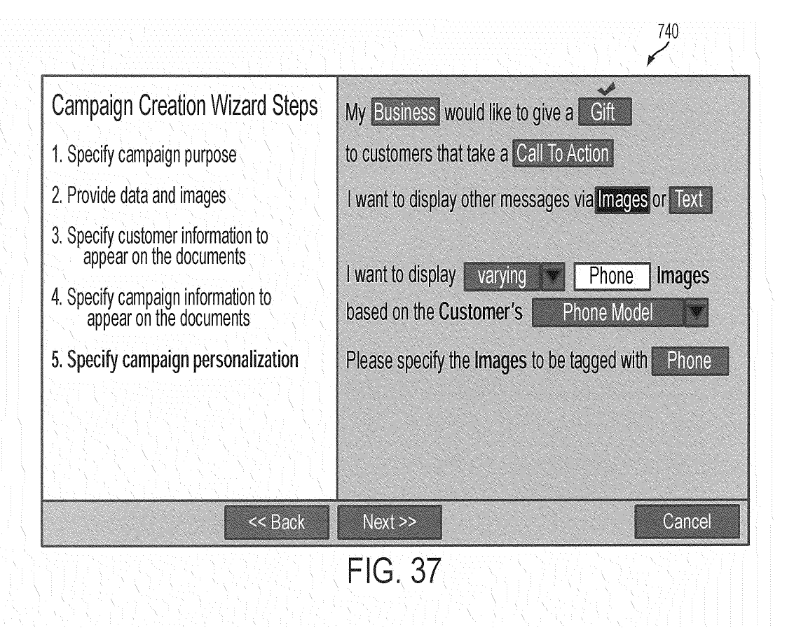

FIG. 37 shows a screenshot 740 from the campaign creation wizard in which the user is prompted to specify pre-stored images that are to be tagged as being phone images.

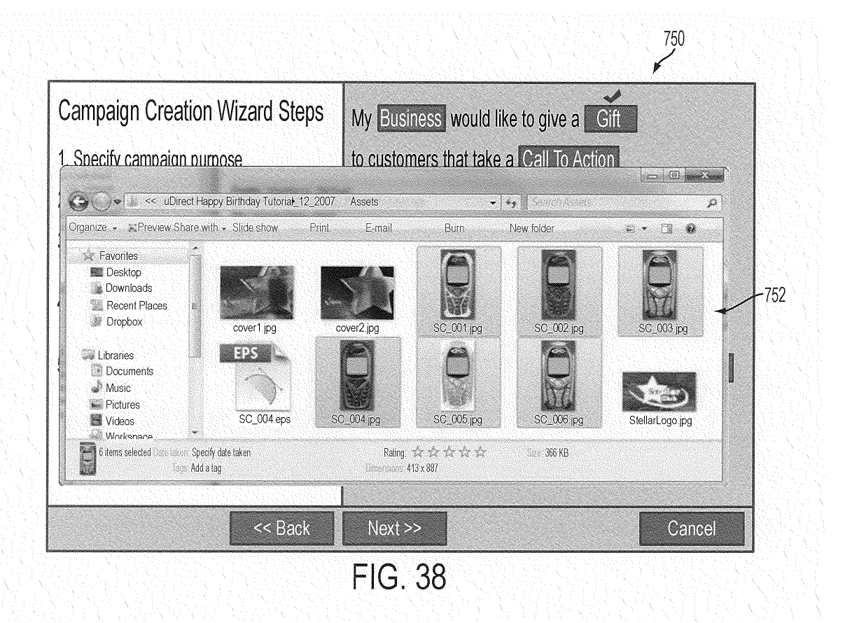

FIG. 38 shows a screenshot 750 from the campaign creation wizard in which the user has selected pre-stored images 752 that are to be tagged as being phone images from a database of pre-stored images related to the marketing campaign.

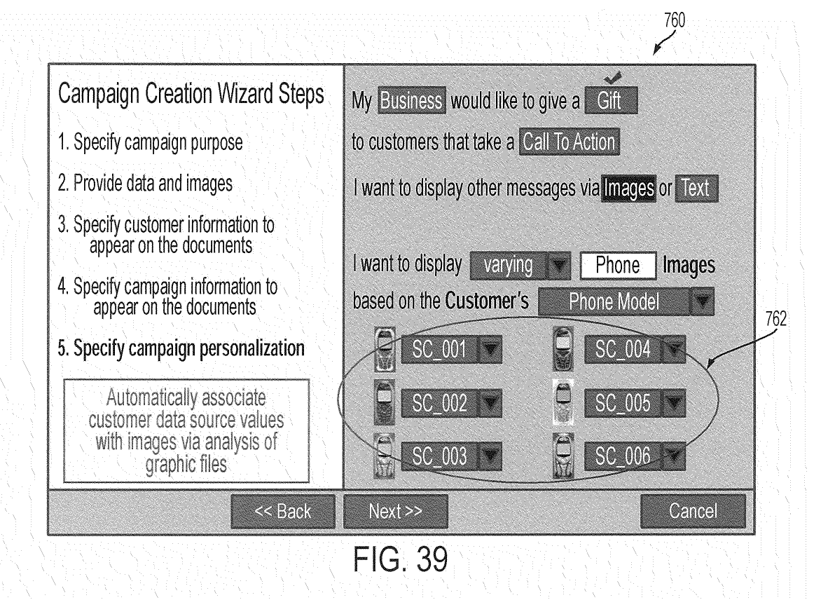

FIG. 39 shows a screenshot 760 from the campaign creation wizard that shows the user that the user-provided customer data source (e.g., a spreadsheet or data base comprising customer names, addresses, phone models, plan levels, status levels, and any other information desired to be used by the campaign designer or user) has been analyzed and source values related to each recipients phone model have been automatically associated with the user-selected phone images 762 via analysis of the selected phone images.

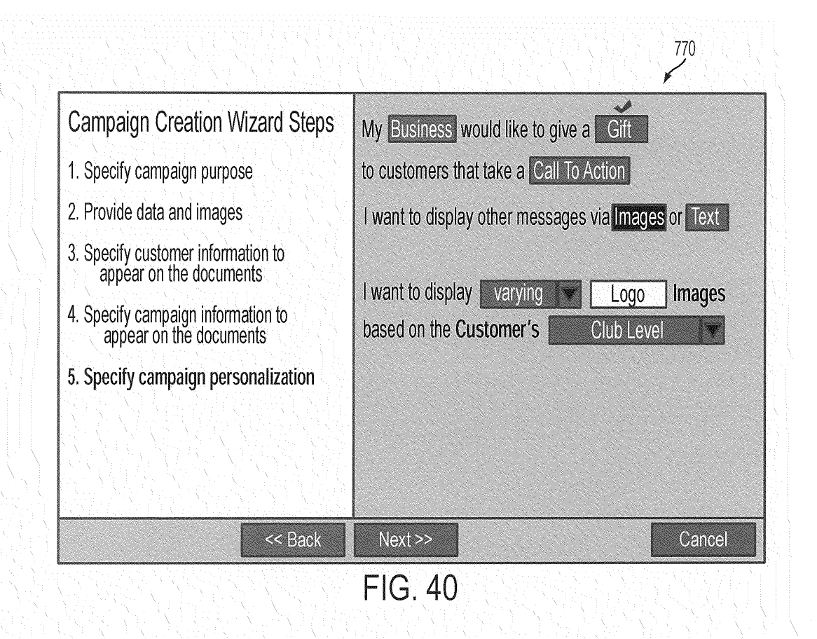

FIG. 40 shows a screenshot 770 from the campaign creation wizard in which the user has selected to display varying logo images based on the recipients' club level.

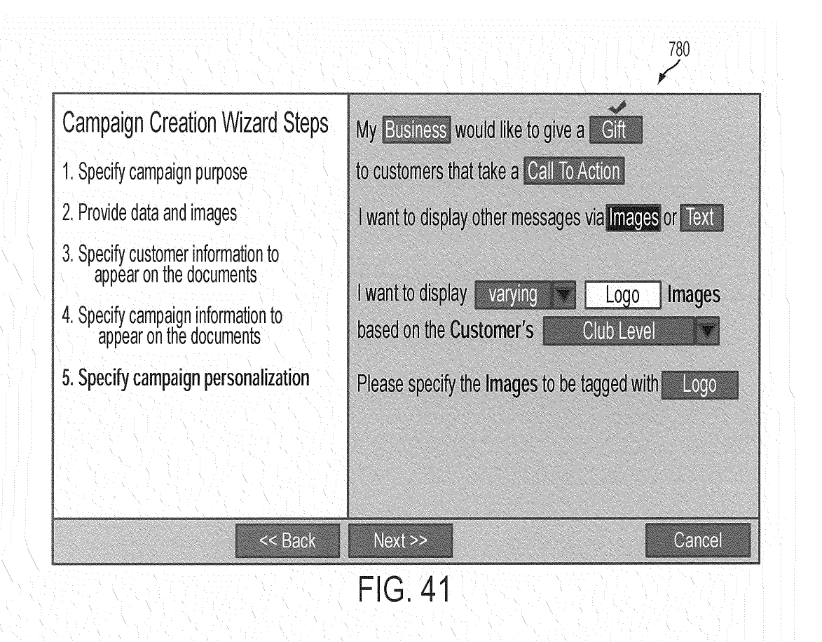

FIG. 41 shows a screenshot 780 from the campaign creation wizard in which the user is prompted to specify pre-stored images that are to be tagged as being logo images.

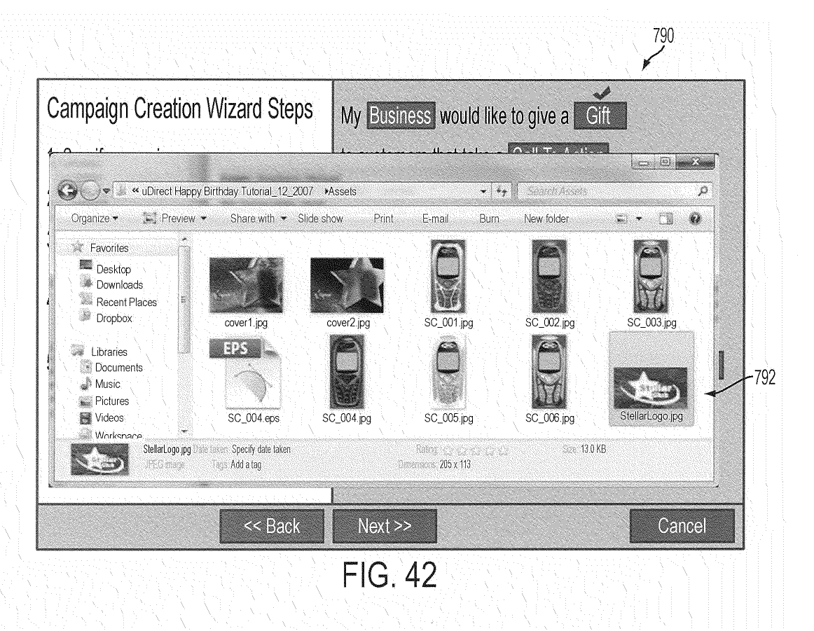

FIG. 42 shows a screenshot 790 from the campaign creation wizard in which the user has selected pre-stored images that are to be tagged as being logo images from a database of pre-stored images related to the marketing campaign. In this example, the user has selected only one pre-stored image as a logo image 792.

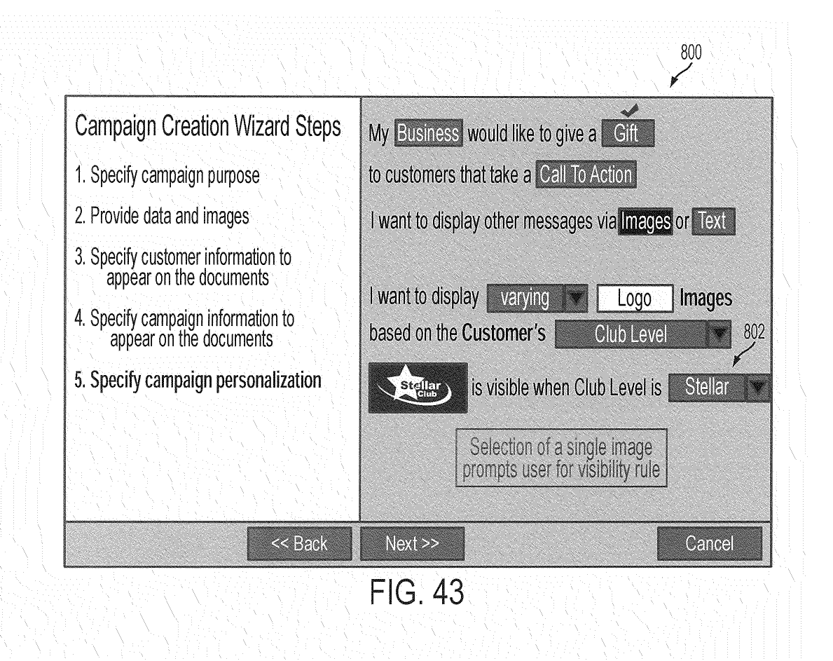

FIG. 43 shows a screenshot 800 from the campaign creation wizard in which the user is prompted to specify a visibility rule from a menu 802 since, in this example, the user selected only one pre-stored image to be tagged as a logo image. Once this step is complete, the user is prompted to specify formats in which to save the marketing campaign, e.g., as one or more of the file types shown in FIG. 23.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A computer-implemented method for personalizing a variable data publishing (VDP) marketing campaign pattern, comprising:
receiving user input related to an intended campaign purpose from a non-expert user;
automatically selecting a VDP pattern from a plurality of a pre-generated VDP pattern as a function of the intended campaign purpose;
retrieving product information to be presented on campaign documents for distribution to a plurality of recipients;
receiving recipient information to appear on the campaign documents;
prompting the user, as a function of the intended campaign purpose, to specify personalization parameters for personalizing the campaign documents;
receiving user-specified personalization parameter information; and
outputting a personalized VDP pattern instance for use in generating the campaign documents.

2. The method according to claim 1, wherein receiving user input related to an intended campaign purpose comprises presenting the user with a plurality of natural language sentences each describing a different campaign purpose, and receiving an indication from the user regarding a selected natural language sentence.

3. The method according to claim 2, further comprising presenting the user with at least one VDP element comprising a natural language sentence having a plurality of selectable element parameters.

4. The method according to claim 3, further comprising receiving an indication that the user has selected at least one of the selectable element parameters.

5. The method according to claim 4, further comprising evaluating the received product information and the received recipient information and presenting the user with selectable product attribute values and recipient attribute values from which the user selects one or more attribute values to be displayed in the campaign documents.

6. The method according to claim 3, wherein the selectable element parameters comprise one or more of:
a personalized product to be offered to the recipient;
a personalized reward to be offered to the recipient;
a restriction placed on a personalized offer made to the recipient; and
a personalized call to action to be performed by the recipient.

7. The method according to claim 1, wherein the plurality of a pre-generated VDP patterns comprises one or more of:
an offer VDP pattern;
an invitation VDP pattern;
a notification VDP pattern;
an announcement VDP pattern; and
a solicitation VDP pattern.

8. The method according to claim 1, wherein the recipient information comprises:
a first name of each recipient;
a last name of each recipient;
an address of each recipient; and
an amount of money spent by each recipient in a given time period for one or more products sold by the user.

9. The method according to claim 1, wherein at least one of the pattern element information and the recipient information is received as a downloaded data source, and further comprising automatically extracting the at least one of the pattern element information and the recipient information from the data source.

10. The method according to claim 9, wherein at least one data source is provided that automatically extends the VDP pattern with a new pattern element representing the contents of the at least one data source.

11. The method according to claim 9, wherein the downloaded data source comprises recipient information stored in at least one of a database and a comma-delimited format.

12. A processor configured to execute computer-executable instructions for performing the method of claim 1, the instructions being stored on a computer-readable medium.

13. A system that facilitates personalizing a variable data publishing (VDP) marketing campaign pattern, comprising:
a graphical user interface (GUI) via which a user interacts with a campaign creation application that is persistently stored on a computer-readable medium; and
a processor that executes the campaign creation application and is configured to:
receive user input related to an intended campaign purpose from a non-expert user;
automatically select a VDP pattern from a plurality of a pre-generated VDP pattern as a function of the intended campaign purpose;
retrieve product information to be presented on campaign documents for distribution to a plurality of recipients, the product information being retrieved from a product data source provided by the user;
receive recipient information to appear on the campaign documents, the recipient information being provided in a recipient data source provided by the user;
prompt the user, as a function of the intended campaign purpose, to specify personalization parameters for personalizing the campaign documents;
receive user-specified personalization parameter information; and
output a personalized VDP pattern instance for use in generating the campaign documents.

14. The system according to claim 13, wherein the user input related to an intended campaign purpose comprises an indication that is received via the GUI from the user regarding a user-selected natural language sentence describing the intended campaign purpose.

15. The system according to claim 14, wherein the processor is further configured to present the user with at least one VDP element comprising a natural language sentence having a plurality of selectable element parameters.

16. The system according to claim 15, wherein the processor is further configured to receive an indication that the user has selected at least one of the selectable element parameters.

17. The system according to claim 16, wherein the processor is further configured to evaluate the received pattern element information and the received recipient information and to present the user with selectable pattern element attribute values and recipient attribute values from which the user selects one or more attribute values to be displayed in the campaign documents.

18. The system according to claim 15, wherein the selectable element parameters comprise one or more of:
a personalized product to be offered to the recipient;
a personalized reward to be offered to the recipient;
a restriction placed on a personalized offer made to the recipient; and
a personalized call to action to be performed by the recipient.

19. The system according to claim 13, wherein the plurality of a pre-generated VDP patterns comprises one or more of:
an offer VDP pattern;
an invitation VDP pattern;
a notification VDP pattern;
an announcement VDP pattern; and
a solicitation VDP pattern.

20. The system according to claim 13, wherein the recipient information comprises:
a first name of each recipient;
a last name of each recipient;
an address of each recipient; and
an amount of money spent by each recipient in a given time period for one or more products sold by the user.

21. The system according to claim 13, wherein the recipient data source is an electronic spreadsheet document that comprises information regarding customers of the user.

22. A computer-readable medium having persistently stored thereon computer-executable instructions for personalizing a variable data publishing (VDP) marketing campaign pattern, comprising instructions for:
receiving user input related to an intended campaign purpose from a non-expert user;
automatically selecting a VDP pattern from a plurality of a pre-generated VDP pattern as a function of the intended campaign purpose;
retrieving product information to be presented on campaign documents for distribution to a plurality of recipients;
receiving recipient information to appear on the campaign documents;
prompting the user, as a function of the intended campaign purpose, to specify personalization parameters for personalizing the campaign documents;
receiving user-specified personalization parameter information; and
outputting a personalized VDP pattern instance for use in generating the campaign documents.
